(19) United States
(12) Patent Application Publication
(10) Pub. No.: US 2018/0202543 A1
(43) Pub. Date: Jul. 19, 2018

(54) SYSTEM AND METHOD FOR SIMULTANEOUS LOAD TRANSFER AND SPEED SYNCHRONIZATION IN GEARSHIFTS INVOLVING MULTIPLE ACTIVELY CONTROLLED CLUTCHES IN AUTOMATIC TRANSMISSIONS

(71) Applicant: Ohio State Innovation Foundation, Columbus, OH (US)

(72) Inventors: Krishnaswamy Srinivasan, Columbus, OH (US); Kirti Mishra, Columbus, OH (US)

(21) Appl. No.: 15/875,567

(22) Filed: Jan. 19, 2018

Related U.S. Application Data
(60) Provisional application No. 62/448,101, filed on Jan. 19, 2017.

(51) Int. Cl. F16H 61/02; B60W 10/113; B60W 10/115; B60W 10/06; B60W 30/19; B60W 10/02; F16H 61/688; F16H 61/686

(52) U.S. Cl. CPC F16H 61/0213; F16H 59/141; B60W 10/115; B60W 10/06; B60W 30/19; B60W 10/02; F16H 61/688; F16H 61/686; B60W 2510/0275; B60W 2510/0283; B60W 2510/0638; B60W 2510/0657; B60W 2510/1025; B60W 2510/1015; B60W 2510/102; B60W 2510/104; B60W 2510/1045; B60W 2520/28; B60W 2520/30; B60W 2710/021; B60W 2710/1005; B60W 2710/0644; B60W 2710/0666; B60W 10/113

(57) ABSTRACT

This invention pertains to the field of power transmission. Machines using a power transmission mechanism for transmission of the mechanical power produced by a source (engine (2), electric motor, pneumatic and hydraulic pump) to another component of the machine (wheel (21), electric motor, electric generator, pneumatic and hydraulic pump) through multiple transmission paths (different gear ratios (14), (15)) are subjects of this invention. It is disclosed that control of a switching from one power transmission path to another is done in a manner involving simultaneous load transfer and speed synchronization rather than sequential performance of these two functions, and the resulting method developed in the invention leads to switching operations that produce less disturbance at the input of the said component. The said method is applied to the problem of controlling gearshifts in automatic transmissions of ground vehicles.

### RELATED APPLICATION

This application claims the filing benefit of U.S. Provisional Patent Application No. 62/448,101 filed on Jan. 19, 2017, the disclosure of which is expressly incorporated by reference herein in its entirety.

### TECHNICAL FIELD

This invention relates generally to the field of power transmission and more particularly to a method of control of stepped automatic transmissions having multiple paths for power transmission.

### BACKGROUND

To propel or perform a useful action, often one needs to rely on machines that consist of a power source that produces mechanical power, quantified in terms of its torque/force production and its speed, and a power-transmission mechanism to transmit this power to a loading element that requires this power to sustain its operation. The power consumed in this operation is quantified by the input torque/force required by the loading element to sustain its speed of operation. The power source may be an internal combustion engine, an electric motor, a hydraulic motor, an pneumatic pump, or other means of storing (and releasing) energy such as springs-, accumulators-, compressed air-based systems, etc., or combination of these. The loading element may be an inertial load in the case of a propulsion system or a resistive load in the case of electricity generation system.

While transmitting the mechanical power from the power source to the loading element, the power-transmission mechanism operates to maximize the efficiency of the power source and quality of loading element operation. These specifications are often difficult to fulfill simultaneously, requiring a need for choosing the best power-transmission path (option) out of all the available power-transmission paths (options). The action of switching from one power transmission path to another is termed as shifting, and is achieved by actuation of power-transmitting devices, which provide necessary reaction torques/forces for the transmission of the mechanical effort produced by the power source. In case of an automotive transmission, this switching between various power transmission paths is termed as garage shifts or gearshifts, the difference being that in garage shifts, the gear ratio remains unchanged before and after the shift, which is not the case for a gearshift. The power-transmitting devices may be clutches, which are often actuated hydraulically, however, examples of electromagnetic actuations are increasingly seen. The gear ratio is a measure of mechanical advantage. Every power transmission mechanism has such a measure.

Often during the production of mechanical power by the power source or consumption of that power by the loading element mechanical, vibrations are generated that are detrimental to the quality of loading element operation and life of mechanical elements in the machine. In order to dampen out these mechanical vibrations and serve other features, a vibration isolation device may be employed. In dual clutch transmissions, these could be mechanical spring-mass dampers or flywheel-based dampers. Planetary automatic transmissions achieve this hydraulically by using a torque converter, which in addition to providing the vibration isolation function, also provides multiplication of torque from the engine to the transmission input shaft.

Stepped automatic transmissions offer a finite number of gear ratios to best match varying load demand with engine performance. Current practice in controlling clutch-to-clutch shifts in stepped automatic transmissions requires separating the load (torque) transfer phase and the speed synchronization phase. The two phases are also known as torque phase and inertia phase, and will be henceforth referred to thus. In up-shifts, for example, from the first to the second gear, the ratio of the engine speed to the vehicle speed decreases, and the ratio of the torque transmitted to the vehicle to the engine torque decreases at the conclusion of the shift. Because the vehicle speed typically does not change much during the shift, the engine speed drops during an upshift, the speed change occurring during the speed synchronization phase.

In recent years, clutch-to-clutch gearshifts have increasingly depended on electronic coordination of torque transfer and speed adjustment of two actively-controlled clutches, rather than mechanical design features which in the past required only one actively controlled clutch. In power-on upshifts, the torque phase occurs first and, during this phase, the oncoming clutch torque is increased and the offgoing clutch torque is decreased so that the transmitted torque is transferred gradually from the offgoing clutch to the oncoming clutch. During the torque phase, the offgoing clutch remains locked, inhibiting significant speed changes of the transmission input speed. Much of torque phase control is done open loop in the absence of torque sensors in transmissions and hence real-time torque feedback. At the end of this phase, the offgoing clutch is transmitting no torque, and starts slipping. The oncoming clutch is then carrying all of the transmitted torque, and is also slipping as the transmission input speed adjustment has not taken place yet. The inertia phase is next where the transmission input speed is synchronized with the oncoming clutch speed by appropriately adjusting the torque on the oncoming clutch. In the case of upshifts, the transmission input speed is higher and is decreased by the oncoming clutch torque until the speed is synchronized. Because transmission input speed is sensed in production transmissions, inertia phase control is usually based upon feedback of speed and comparison with a desired speed trajectory. During power-on downshifts, the sequencing of the two phases is reversed, with the inertia phase occurring before the torque phase.

The sequential nature of the two shifts results from depending on friction devices for torque transmission and intentionally separating the torque phase of the shift from the inertia phase. Friction devices operate very differently when they are slipping as compared to when they are locked. In the former (slipping) case, the torque transmitted by the friction device depends on the clutch pressure, clutch geometry and friction characteristics, and the clutch slip speed. In the latter (locked) case, the mating clutch plates move together and the transmitted torque depends on this motion as well as the load mechanical characteristics. Importantly, the transmitted torque does not depend on the clutch pressure for such clutches, as long as the capacity of the clutch to transmit torque exceeds the torque needed to sustain the load motion.

The use of friction devices to control shifts, and the fact that one of the clutches is in the locked mode during the torque phase, simplifies the control of the torque phase in the sense that the only variable being controlled is the torque being transferred. Accurately controlling the transfer of torque, however, is hindered by the absence of real-time torque feedback, resulting in open loop control. Similarly, during the inertia phase, both clutches are slipping but one of the clutches is not transmitting torque. The only variable usually being controlled then is the speed of the other clutch, which can be controlled accurately because it is based upon feedback of the controlled speed or clutch slip speed. Consequently, the conventional mode of clutch-to-clutch shift control during shifts leads to relative ease of control because only one variable is actively controlled at any one time.

The conventional mode of clutch control during shifts results usually in longer shift duration because of the sequencing of the torque phase and inertia phase. Shortening the duration of the shift by shortening either or both the torque and inertia phases while using the conventional mode of shift control would result in a harsher shift. The nature of the transmission output torque transient occurring during the shift depends on the engine torque variation during the shift. If the engine torque does not change much during an upshift, there is a drop in the transmission output torque followed by a rise and a subsequent fall in the torque, well-known as the “torque hole” phenomenon. Engine torque management during the shift can change this transient, and is commonly employed as part of an integrated powertrain control approach to improving shift performance by softening the output torque transient during the inertia phase. However, such engine torque management for improving shift quality compromises other objectives of engine torque management such as efficiency and emission control. The basic limitation that results from sequencing of the torque and inertia phases remains unchanged and ultimately limits the achievable improvement in overall powertrain performance.

### SUMMARY

According to one embodiment of the invention, a method for simultaneously controlling transfer of load and synchronization of speed between actively controlled power transmitting devices during a gearshift in a stepped automatic transmission connected to a loading element, and acted upon by a transmission input torque trajectory is disclosed. In one embodiment, the method comprises specifying an h^{th} rate of change of a transmission input speed trajectory having n−h input parameters, where h is a nonnegative integer, n is a positive integer, and n−h>0. When h>0, integrating the h^{th} rate of change of the transmission input speed trajectory h times to calculate the transmission input speed trajectory and remaining h input parameters as constants of integration, so that a total number of input parameters associated with the transmission input speed trajectory is n. Specifying a q^{th} rate of change of a loading element input torque trajectory having m−q output parameters, where q is a nonnegative integer, m is a positive integer, and m−q>0. When q>0, integrating the q^{th} rate of change of the loading element input torque trajectory q times to calculate the loading element input torque trajectory and remaining q output parameters as constants of integration, so that a total number of output parameters associated with the loading element input torque trajectory is m. Calculating a loading element velocity trajectory based on the loading element input torque trajectory. Calculating a transmission output speed trajectory based on the loading element input torque trajectory and the loading element velocity trajectory. Differentiating the transmission output speed trajectory to calculate a transmission output acceleration trajectory. Calculating a power transmitting device torque trajectory for each of the transmitting devices based on the transmission output acceleration trajectory, the loading element input torque trajectory, a transmission input acceleration trajectory, and the transmission input torque trajectory. Calculating a power transmitting device speed trajectory for each of the transmitting devices based on the transmission input speed trajectory and the transmission output speed trajectory. Assigning numerical values to a subset of the n input and m output parameters, the subset including m+n−p parameters, where p is a nonnegative integer less than m+n. Calculating numerical values for remaining p parameters, which were not included in the subset of n input and m output parameters receiving assigned numerical values, by satisfying p constraints on initial values of the loading element input torque trajectory, the first rate of change of the loading element input torque trajectory with respect to time, initial value of the transmission input speed trajectory, and initial and final values of the torque and speed trajectories of selected power transmitting devices. Calculating the torque and speed trajectories of the power transmitting devices using the numerical values of the m+n parameters. Controlling the power transmitting devices in a manner prescribed by the torque and speed trajectories during a gearshift.

In one aspect the method further comprises differentiating the power transmitting device speed trajectory for selected power transmitting devices to calculate a power transmitting device acceleration trajectory for the selected power transmitting devices. Unassigning numerical values for k parameters, where k is a positive integer and p+k<m+n. Wherein the step of calculating numerical values further includes calculating numerical values for k more parameters by satisfying k more constraints on initial and final values of power transmitting device acceleration trajectories for the selected power transmitting devices.

In another aspect of the method, the loading element is an automotive vehicle, the stepped automatic transmission is a dual clutch transmission, the power transmitting devices are clutches, and a constant source torque produced by an internal combustion engine, another prime mover, or a combination thereof is transmitted by a vibration isolation device to produce a transmission input torque, and the method further comprises calculating the transmission input torque trajectory based on the transmission input speed trajectory and the source torque.

In yet another aspect of the method the loading element is an automotive vehicle, the stepped automatic transmission is a dual clutch transmission, the power transmitting devices are clutches, and a source torque produced by a power source is transmitted by a vibration isolation device to produce a transmission input torque, and the method further comprises specifying a r^{th} rate of change of a source speed trajectory, where r is a nonnegative integer. If r>0, integrating the r^{th} rate of change of the source speed trajectory r times to calculate the source speed trajectory and r+1 times to calculate a source position trajectory. Unassigning numerical values for m-4 parameters out of the already assigned m+n−p parameters, and assigning numerical values to a subset of the m output parameters, the subset including m-3 parameters. Integrating the transmission output speed trajectory to calculate a transmission output position trajectory. Calculating a final value of the transmission output position trajectory. Calculating a final value of the transmission output speed trajectory. Calculating a final value of the transmission input speed trajectory based on a current gear ratio and the final value of the transmission output speed trajectory. Calculating a final value of the transmission input position trajectory based on the current gear ratio and the final value of the transmission output position trajectory. Calculating a final value of the transmission input torque trajectory based on the final value of the source position trajectory, the source speed trajectory, the transmission input speed trajectory, and the transmission input position trajectory. Wherein the step of calculating numerical values further includes calculating a numerical value of one more parameter by satisfying an additional constraint on final value of the driveshaft torque trajectory. Calculating a vibration isolation device input torque trajectory based on the source position trajectory, the source speed trajectory, the transmission input speed trajectory, and the transmission input position trajectory. Calculating a source torque trajectory based on the source speed trajectory and the vibration isolation device input torque trajectory. Controlling the power source in a manner prescribed by the source torque trajectory and the source speed trajectory during a gearshift.

In yet another aspect of the method the loading element is an automotive vehicle, the stepped automatic transmission is a planetary automatic transmission, the power transmitting devices are clutches, and a source torque produced by power source is transmitted by a torque converter to produce a transmission input torque, the method further comprises specifying a r^{th} rate of change of a source speed trajectory, where r is a nonnegative integer. If r>0, integrating the r^{th} rate of change of the source speed trajectory r times to calculate the source speed trajectory. Unassigning numerical values for m-4 parameters out of the already assigned m+n−p parameters, and assigning numerical values to a subset of the m output parameters, the subset including m-3 parameters. Calculating a final value of the transmission output speed trajectory. Calculating a final value of the transmission input speed trajectory based on a current gear ratio and the final value of the transmission output speed trajectory. Calculating a final value of the transmission input torque trajectory based on the final value of the source speed trajectory and the transmission input speed trajectory. Wherein the step of calculating numerical values further includes calculating a numerical value of one more parameter by satisfying an additional constraint on final value of the driveshaft torque trajectory. Calculating a torque converter input torque trajectory based on the source speed trajectory and the transmission input speed trajectory. Calculating a source torque trajectory using the source speed trajectory and the torque converter input torque trajectory. Controlling the power source in a manner prescribed by the source torque trajectory and the source speed trajectory during a gearshift.

In one aspect of the method wherein the clutches are hydraulically powered, the hydraulically powered clutches being controllable by commanding solenoid valves, and the method further comprises calculating reference clutch pressure trajectories by using the power transmitting device torque trajectories. Calculating commands for the solenoid valves based on the reference clutch pressure trajectories. Controlling the solenoid valves in a manner specified by these calculate commands.

In another embodiment of the invention, a controller for simultaneously controlling transfer of load and synchronization of speed between actively controlled power transmitting devices during a gearshift in a stepped automatic transmission connected to a loading element, and acted upon by a transmission input torque trajectory is disclosed. The controller is configured to specify an h^{th} rate of change of a transmission input speed trajectory having n−h input parameters, where h is a nonnegative integer, n is a positive integer, and n−h>0; when h>0, integrate the h^{th} rate of change of the transmission input speed trajectory h times to calculate the transmission input speed trajectory and remaining h input parameters as constants of integration, so that a total number of input parameters associated with the transmission input speed trajectory is n; specify a q^{th} rate of change of a loading element input torque trajectory having m−q output parameters, where q is a nonnegative integer, m is a positive integer, and m−q>0; when q>0, integrate the q^{th} rate of change of the loading element input torque trajectory q times to calculate the loading element input torque trajectory and remaining q output parameters as constants of integration, so that a total number of output parameters associated with the loading element input torque trajectory is m; calculate a loading element velocity trajectory based on the loading element input torque trajectory; calculate a transmission output speed trajectory based on the loading element input torque trajectory and the loading element velocity trajectory; differentiate the transmission output speed trajectory to calculate a transmission output acceleration trajectory; calculate a power transmitting device torque trajectory for each of the transmitting devices based on the transmission output acceleration trajectory, the loading element input torque trajectory, a transmission input acceleration trajectory, and the transmission input torque trajectory; calculate a power transmitting device speed trajectory for each of the transmitting devices based on the transmission input speed trajectory and the transmission output speed trajectory; assign numerical values to a subset of the n input and m output parameters, the subset including m+n−p parameters, where p is a nonnegative integer less than m+n; calculate numerical values for remaining p parameters, which were not included in the subset of n input and m output parameters receiving assigned numerical values, by satisfying p constraints on initial values of the loading element input torque trajectory, the first rate of change of the loading element input torque trajectory with respect to time, initial value of the transmission input speed trajectory, and initial and final values of the torque and speed trajectories of selected power transmitting devices; calculate the torque and speed trajectories of the power transmitting devices using the numerical values of the m+n parameters; and control the power transmitting devices in a manner prescribed by the torque and speed trajectories during a gearshift.

In one aspect of the controller, at least one of the trajectories and the numerical values are pre-calculated and loaded into a memory of the controller, and the controller determines the at least one of the trajectories and the numerical values by retrieving the at least one of the trajectories and the numerical values from the memory.

In another aspect of the controller, the controller comprises a micro-processor and a memory in communication with the micro-processor, the memory containing instructions that, when executed by the micro-processor, cause the controller to operate as configured.

### BRIEF DESCRIPTION OF THE DRAWINGS

The accompanying drawings, which are incorporated in and constitute a part of this specification, illustrate embodiments of the invention and, with a detailed description of the embodiments given below, serve to explain the principles of the invention.

FIG. 1 is a schematic representation of a loading device, such as an automotive vehicle in one embodiment, and the physical architecture of an automotive powertrain including a high-level representation of one embodiment of the invention.

FIG. 1A is a schematic representation of a vibration isolation device for use in an automotive powertrain in another embodiment of the invention.

FIG. 2 is a schematic representation of the computational routines used for real-time estimation and their use, along with sensed variables, for engine and clutch pressure control.

FIG. 3 is a schematic representation of one embodiment of a subroutine inside the real-time estimator (38) for estimating driveshaft torque.

FIG. 4 is a schematic representation of one embodiment of the engine torque management system.

FIG. 5 is a schematic representation of one embodiment of the open loop control system for clutch pressure.

FIG. 6 is a schematic representation of one embodiment of the architecture for closed loop control of clutch pressures.

FIG. 7 shows reference clutch and predicted driveshaft torque trajectories for a 1-2 power-on upshift, calculated for a dual clutch transmission (DCT) type powertrain.

FIG. 8 shows reference oncoming clutch slip trajectory, and predicted turbine and transmission output speeds for a 1-2 power-on upshift, calculated for a DCT type powertrain.

FIG. 9A shows reference clutch torque trajectories, and predicted driveshaft and turbine torque trajectories, calculated for planetary automatic transmission (AT) type powertrain.

FIG. 9B shows reference engine indicated torque trajectory, also calculated for AT type powertrain.

FIG. 10A shows the predicted turbine, transmission output, and engine speeds, along with the ratio of turbine and pump speeds, denoted by s, and the threshold for the torque converter mode switch, denoted by s*. FIG. 10B shows the reference oncoming clutch slip speed trajectory. The trajectories shown in FIGS. 10A and 10B correspond to AT type powertrain.

FIGS. 11A and 11B show the simulation results for forward simulation of AT type powertrain corresponding to reference trajectories (open loop controls) shown in FIGS. 9A-10B. FIG. 11A shows the turbine and driveshaft torque trajectories, and FIG. 11B shows the turbine, oncoming clutch slip, offgoing clutch slip, and vehicle speeds.

FIGS. 12A-14B show the simulation results for forward simulation of AT type powertrain corresponding to reference trajectories (open loop controls) shown in FIGS. 9A and 9B with added hydraulic, first gear, and second gear dynamic models. FIG. 12A shows the engine indicated and driveshaft torque trajectories; FIG. 12B shows trajectories for the turbine torque, offgoing clutch torque and torque capacity, and oncoming clutch torque and torque capacity; FIG. 13A shows the turbine, engine, and vehicle speed trajectories; FIG. 13B shows slip speed trajectories for the offgoing clutch and oncoming clutch; FIGS. 14A and 14B show clutch pressure tracking performance for the oncoming clutch and offgoing clutch respectively.

FIGS. 15A-17B show the simulation results for forward simulation of AT type powertrain with added hydraulic, first gear, and second gear dynamic models, corresponding to reference trajectories (open loop controls) calculated to achieve a constant driveshaft torque during the gearshift. FIG. 15A shows trajectories for the turbine torque, offgoing clutch torque and torque capacity, and oncoming clutch torque and torque capacity; FIG. 15B shows the engine indicated and driveshaft torque trajectories; FIG. 16A shows slip speed trajectories for the offgoing clutch and oncoming clutch; FIG. 16B shows the turbine, engine, and vehicle speed trajectories; FIGS. 17A and 17B show clutch pressure tracking performance for the oncoming clutch and offgoing clutch respectively.

FIGS. 18A-19B show the simulation results for forward simulation of AT type powertrain with added hydraulic, first gear, and second gear dynamic models, corresponding to reference trajectories (open loop controls) calculated to achieve a constant driveshaft torque during the gearshift and smooth clutch lock-up. FIG. 18A shows trajectories for the turbine torque, offgoing clutch torque and torque capacity, and oncoming clutch torque and torque capacity; FIG. 18B shows the engine indicated and driveshaft torque trajectories; FIG. 19B shows slip speed trajectories for the offgoing clutch and oncoming clutch; FIG. 19A shows the turbine, engine, and vehicle speed trajectories.

### DETAILED DESCRIPTION

In terms of nomenclature, the speed at the output of a power source, or possibly a combination of power sources, is termed as the power source speed, and the net torque produced by a power source or combination of power sources is termed as the power source torque. The power source may be an internal combustion engine, another prime mover (i.e., an electric motor or a pneumatic or hydraulic pump), or a combination thereof. The torque at the input of a vibration isolation device is termed as the vibration isolation device input torque, which in case of a planetary automatic transmission is known as the pump torque. The transmission input torque is also known as the turbine torque for planetary automatic transmissions. Similarly, torque at the input of the loading element is called the loading element input torque, and its speed is termed as the loading element input speed. Power transmitting devices, clutches for example, inside a stepped automatic transmission carry reaction torques, known as the power transmitting device torque, and the speed attained by a power transmitting device is termed as the power transmitting device speed. For automotive application, these are clutch torque (or torque capacity) and clutch slip speed.

The invention is applicable to machines having a stepped automatic transmission for power transmission between a power source and a loading element. The term stepped automatic transmission is to be understood as a category of power-transmission mechanisms where there are multiple paths for power-transmission each having its own mechanical advantage measure value, such as a gear ratio, and the shifting between different paths is done automatically by a controller in a programmed manner, as opposed to manually, for example in case of manual transmissions.

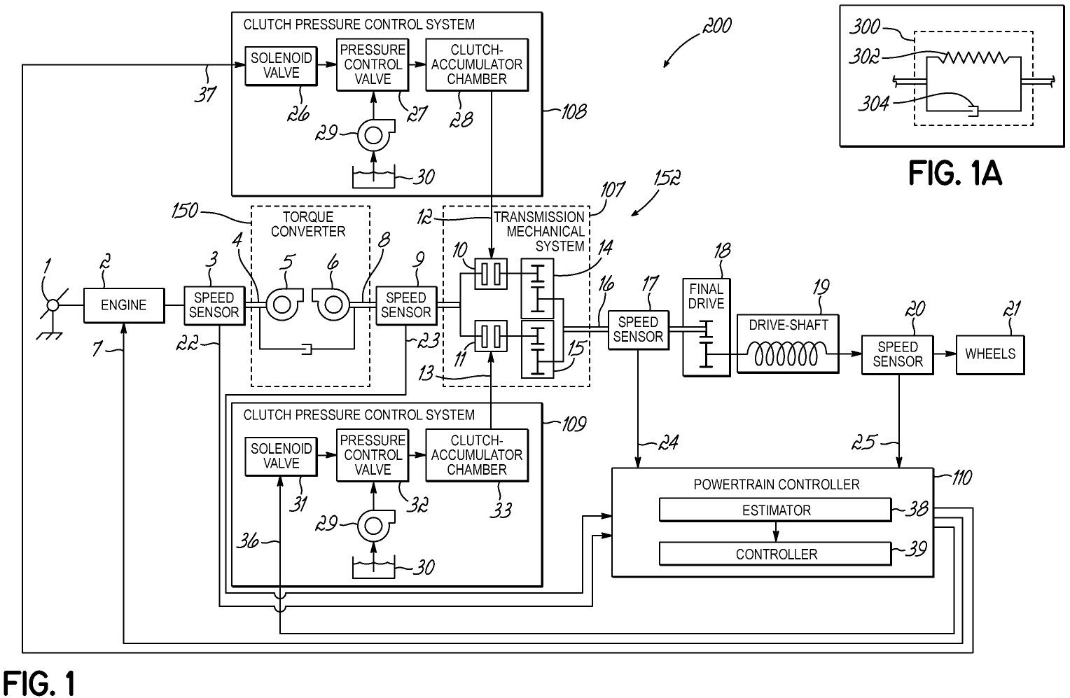

FIG. 1 schematically depicts a loading element (200), such as an automotive vehicle in this embodiment, and the architecture of a powertrain within the automotive vehicle (200). The powertrain includes an engine (2) as the prime mover, a three-element torque converter (150) with pump (5) and turbine (6), a stepped automatic transmission (152) (comprising a transmission mechanical system (107) and clutch pressure control systems (108, 109)), a final drive planetary gear set (18), a compliant drive shaft (19), and vehicle inertia lumped at the (powered) wheels (21). In addition to these components, there are speed sensors (3, 9, 17, 20) mounted on the shafts (4, 8, 16, 19), respectively. These speed sensors send information to a powertrain controller (110) containing the controller (39) and estimator (38) routines, which are mathematical functions coded into an appropriate micro-processor, and/or stored as instructions in a memory in communication with the micro-processor. The speed sensors (3, 9, 17, 20) sense the engine (pump), transmission input (turbine), transmission output, and wheel speeds, respectively. The engine (2) receives throttle angle commands from the driver through the accelerator pedal (1) or, alternatively, a throttle position controller not shown in this implementation. The powertrain controller (110), based on calculations to be described later, sends the throttle angle and/or spark advance command (7) to the engine (2). Also, as shall be described later, the powertrain controller (110) performs calculations to generate commands (36, 37) for the solenoid valves (31, 26) controlling power transmitting devices and, according to one embodiment, offgoing clutch (11) and oncoming clutch (10).

The transmission mechanical system (107), in FIG. 1, comprises the two clutches involved in a clutch-to-clutch (CTC) shift, more specifically the offgoing clutch (11), and the oncoming clutch (10). Items (14) and (15) represent the gear ratios in the oncoming and offgoing clutch paths, illustrating two power transmission paths having different values of mechanical advantage measure. Clutches (10, 11) are manipulated through clutch pressures (12, 13) generated by clutch pressure control systems (108, 109). The clutch pressure control systems (108, 109) consist of solenoid valves (26, 31), which control pressure control valves (27, 32), which in turn control pressures in the clutch-accumulator chambers (28, 33). The motion of the spools (not shown) in the pressure control valves (27, 32), in conjunction with the main line pressure generated by a pump (29) connected to an oil reservoir (30) modulates the pressures in the clutch-accumulator chambers (28, 33).

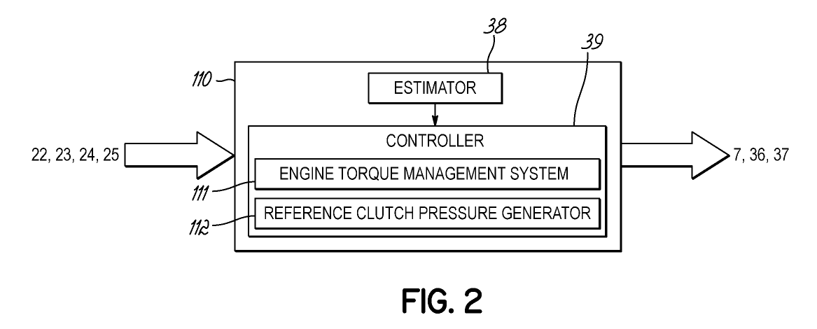

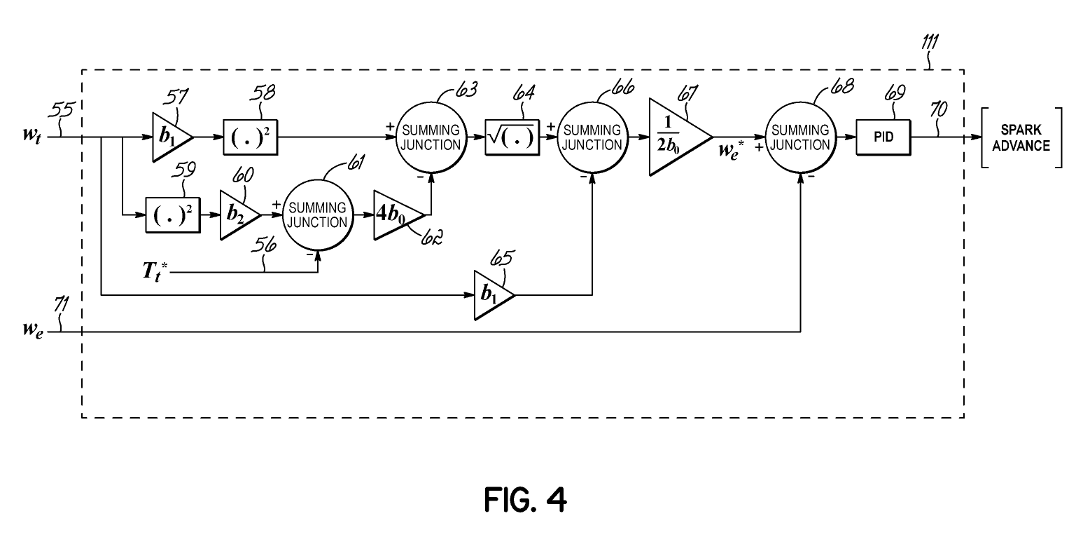

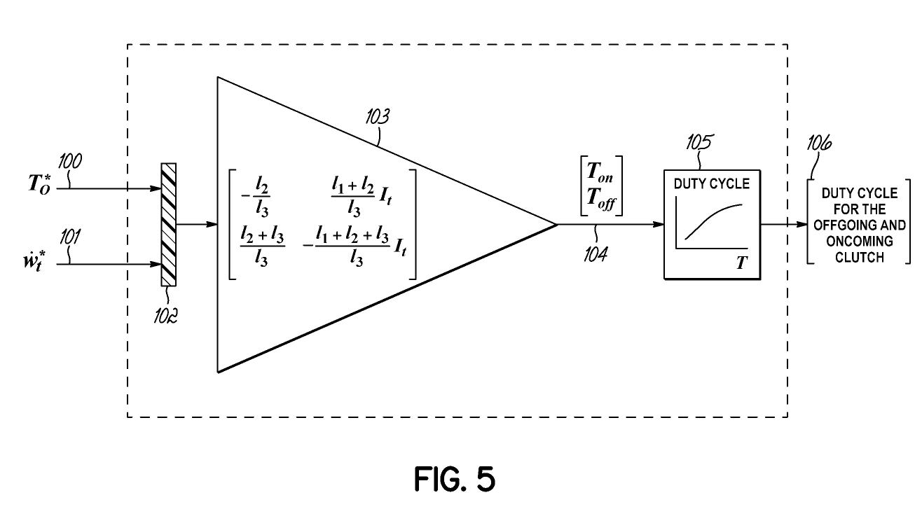

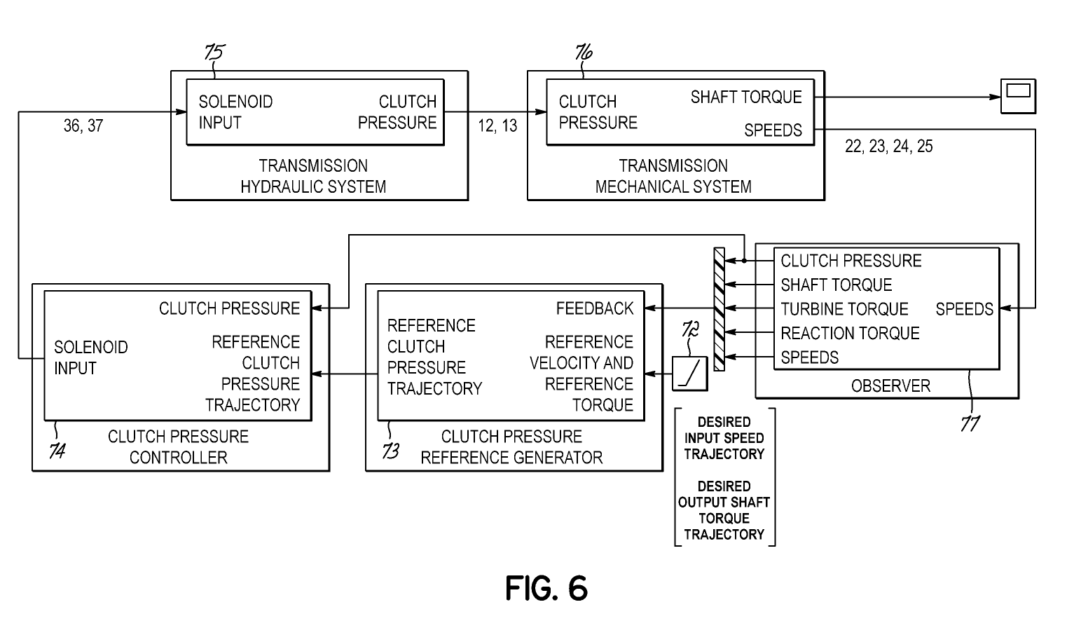

FIG. 2 is a schematic representation of the high-level organization of different routines in the powertrain controller (110). In addition, FIG. 2 shows the flow of information. The information sensed through the speed sensors (22, 23, 24, 25) is used to estimate the output shaft toque (the torque transmitted through the drive-shaft (19)), in addition to other key operating variables such as clutch torques, clutch pressures, and turbine torque, which is sent to the controller (39). The controller (39) comprises an engine torque management system (111) (described in detail in FIG. 4) to exercise integrated powertrain control and a reference clutch pressure generator (112) to manipulate the offgoing and the oncoming clutch pressures (the closed loop version described in FIG. 6, and the open loop version described in FIG. 5). Controller (39) generates control signals (7, 37, 36) for the operation of the spark advance control in the engine (2) and the solenoid valves (31, 26). The control signal (7) is the same as the control signal (70) in FIG. 4, and signals (36) and (37) are embedded in the signal (106) in FIG. 5.

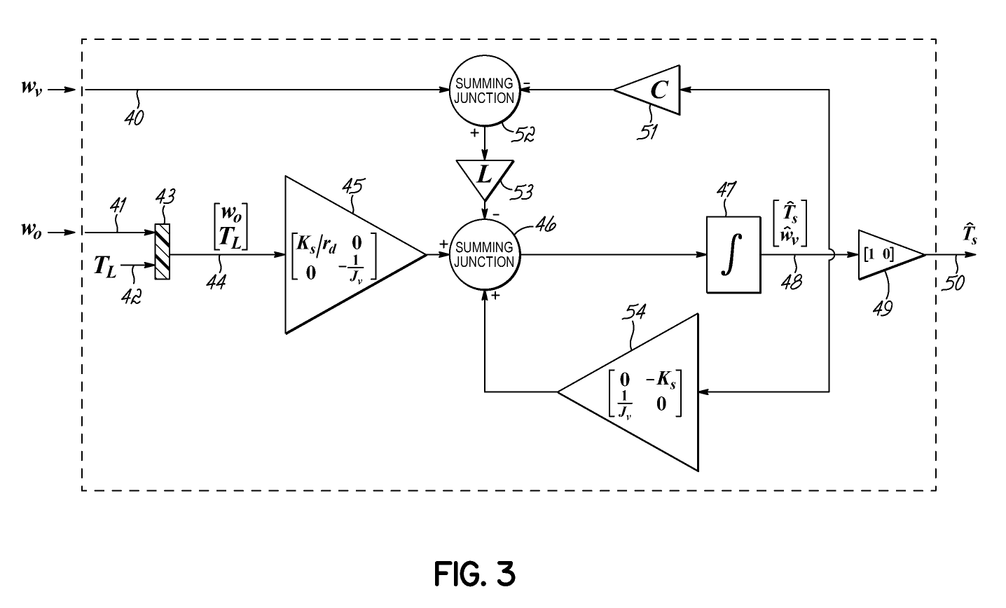

The controller (39) requires information about the output shaft torque (Tₛ) being transmitted through the compliant shaft (19) and information on other key operating variables such as clutch torques, clutch pressures, and turbine torque. Because production transmissions lack torque sensors, and in most cases clutch pressure sensors, an estimator (38) is designed for obtaining information on output shaft torque, turbine torque, clutch pressure, and clutch torques for monitoring and control goals. FIG. 3 is a schematic representation of a part of this real-time estimator. This subroutine of the estimator (38) is a standard Luenberger observer, where the observer gain, L (53), can be selected to ensure robustness with respect to the driveshaft (19) compliance (Kₛ), which is usually not known to a sufficient degree of accuracy. The subroutine implemented in FIG. 3 is given by equation (1).

$$[ \begin{matrix}{\dot{\hat{T}}}_{s} \\ {\dot{\hat{ω}}}_{v}\end{matrix} ] = [ \begin{matrix}0 & - {K}_{s} \\ \frac{1}{{J}_{v}} & 0\end{matrix} ] [ \begin{matrix}{\hat{T}}_{s} \\ {\hat{ω}}_{v}\end{matrix} ] + [ \begin{matrix}{K}_{s} & 0 \\ 0 & - \frac{1}{{J}_{v}}\end{matrix} ] [ \begin{matrix}\frac{{ω}_{o}}{{r}_{d}} \\ {T}_{L}\end{matrix} ] - L ( {ω}_{v} - {\hat{ω}}_{v} ) \qquad ( 1 )$$

As used herein, the symbol “̂” denotes an estimate; the vector [\hat{T}ₛ,\hat{ω}ᵥ]^{T} (48) denotes the estimates of the output shaft torque and the wheel (21) velocity ωᵥ (40) respectively. The quantity Jᵥ denotes the vehicle inertia lumped at the wheel, T_{L} (42) denotes the lumped load torque on the wheel, due to different kinds of road load such as, but not limited to, aerodynamic forces, friction forces, and road grade. The quantity ωₒ (41) represents the speed of the output shaft (16) of the transmission, and r_{d} denotes the final drive gear ratio. The matrix C (51) is called the output matrix, and is given as [0 1]. The triangular blocks in the diagram represent gains (45, 49, 51, 54), the circular blocks represent summing junctions (46, 52). Equation (1) is integrated by an integrator (47). For compactness, the scalar signals are combined to give a vector signal via a multiplexer (43). In an analog setting, the gain blocks (45, 49, 51, 54), summing junction blocks (46, 52), and integrator block (47) can be realized by using operational amplifiers and passive elements such as resistors, inductors, and capacitors. If the shaft torque estimator, described in FIG. 3, is to be digitally implemented, these blocks (operations) will be coded in the software.

FIG. 4 is a schematic representation of the engine torque management system (111). The engine torque management system (111) modulates the turbine torque Tₜ transmitted through the shaft (8) to match a pre-calculated desired torque trajectory Tₜ*(56). The specifics of this calculation will be described later; the methodology is described here. A common way to model a torque converter is to use the widely accepted Kotwicki's model, which is a phenomenological model relating the turbine (6) torque and the pump (5) torque transmitted through the shaft (4) to the engine speed ωₑ (speed of the shaft 4, 71) and the input speed of the transmission ωₜ (speed of the shaft 8, 55). The turbine torque expression is presented in equation (2).

Tₜ=b₀ωₑ²+b₁ωₑωₜ+b₂ωₜ² (2)

where b₀, b₁, b₂ are known parameters. Equation (2) is solved for ωₑ, which is shown in equation (3).

$${ω}_{e} = \frac{- {b}_{1} {ω}_{t} + \sqrt{{( {b}_{1} {ω}_{t} )}^{2} - 4 {b}_{0} ( {b}_{2} {ω}_{t}^{2} - {T}_{t} )}}{2 {b}_{0}} \qquad ( 3 )$$

Equation (4) is used to get the desired engine speed (ωₑ*) in order to achieve the turbine torque trajectory Tₜ* for a given input speed trajectory ωₜ, i.e.,

$${ω}_{e}^{*} = \frac{- {b}_{1} {ω}_{t} + \sqrt{{( {b}_{1} {ω}_{t} )}^{2} - 4 {b}_{0} ( {b}_{2} {ω}_{t}^{2} - {T}_{t}^{*} )}}{2 {b}_{0}} \qquad ( 4 )$$

The calculation shown in equation (4) is realized through summing junctions (61, 63, 66, 68), gain blocks (57, 60, 62, 65, 67), the blocks performing squaring (58, 59), and a block performing square root operation (64). The desired engine speed is sent to a PID controller (69), which receives the sensed engine speed information ((22), same as (71)), and uses the error difference between the two speeds computed by summing junction (68) to modulate the spark advance (70), same as (7) in FIG. 1, to achieve the desired speed, thus ensuring the desired turbine torque Tₜ*. The blocks (58, 64, and 59) can be realized through operational amplifiers and passive electrical components in an analog setting. In a digital setting, these operations would be coded in the software.

Two different implementations of the clutch pressure control system (108, 109) are described: first, an open loop implementation, and second, a closed loop implementation. The open loop control system is detailed in FIG. 5, while the closed loop implementation is detailed in FIG. 6. Closed loop control is required for robust implementation. Thus, the model used to derive the closed loop control law should be of sufficiently high fidelity, which is the reason for including compliance of the drivetrain, and lumping it with the driveshaft compliance. In comparison to this, the open loop control law is useful in demonstrating the feasibility of a control idea at a preliminary stage, and later translates into a feedforward control law, which is often used in conjunction with feedback control. Thus it is reasonable to simplify the model for ease of analysis, justifying omission of the compliance in the drivetrain model. Results demonstrating the effectiveness of open loop control are discussed below.

One goal of the invention is to (gradually) release the offgoing clutch (11) at the onset of the gearshift, thus giving two simultaneously slipping clutches at the start of the gearshift, which yields an extra degree of control freedom compared to the conventional method of clutch-to-clutch shift control, where during the torque phase the offgoing clutch (11) is locked and only the oncoming clutch (10) can be controlled. This situation however changes during the inertia phase, where both clutches are simultaneously slipping, but still there is only one degree of freedom in the conventional approach as the offgoing clutch (11) is not loaded and is fully released. In addition to an extra degree of control freedom as compared to the conventional method for controlling clutch-to-clutch shifts, the invention provides the availability of speed information throughout the shift that can be used for on-line estimation. By contrast, in the conventional method, the offgoing clutch (11) is locked in the torque phase, implying very small speed change of the input shaft during the torque phase.

In the implementation described here, at the start of the gearshift, the offgoing clutch (11) carries the complete load, and the oncoming clutch (10) is barely loaded. On the other hand, the oncoming clutch (10) is fully released, while the offgoing clutch (11) is barely slipping. The open loop control methodology involves selection of suitable trajectories for the input speed ωₜ* (101), or more generally the transmission input speed, and the driveshaft torque Tₛ*, or more generally the loading element input torque trajectory, which when substituted in the inverse of a part of the system's equation of motion (equation (5)) provides Tₒ*(100). The trajectories ωₜ* and Tₒ*are used in the inverse kinematic equations represented by (103) in FIG. 5, providing the open loop clutch torques Tₒₙ and T_{off} (104). Clutch pressures are derived using suitable relationships appropriate for slipping clutches, which can further be used to calculate the appropriate duty cycles (106) for the solenoid valve using look-up tables (105). Doing so, simultaneous load transfer at the output of the transmission and speed synchronization at the input of the transmission are achieved.

In order to demonstrate validity of the innovative gear-shifting method, whereby the two specifications of a gearshift, namely, load transfer and speed synchronization, are achieved simultaneously, a series of computer simulation studies were carried out. The gearshifts controlled in this manner are henceforth called parallel clutch-to-clutch (CTC) gearshifts. Due to the modularity in the model structure, the powertrain model used for performing computer simulation studies can be used to simulate powertrains equipped with dual clutch transmissions (DCT) or planetary automatic transmissions (AT), the difference between the two being the presence of a torque converter in powertrains equipped with planetary automatic transmissions; the model is described below. In its AT-configuration, the model comprises the engine, torque converter, planetary gearbox, friction clutches, shift hydraulic system, driveline compliance, and vehicle inertia lumped at the powered wheels. In its DCT-configuration, the torque converter is not included in the powertrain model, in place of which a vibration isolation device is included; more particularly, a mechanical spring-mass damper. Thus, in a DCT-configuration, the torque converter (150) in the AT-configuration shown in FIG. 1 is replaced by a vibration isolation device (300) as shown in FIG. 1A, but the other components shown in FIG. 1 remain. The vibration isolation device (300) includes a spring (302) and a damper (304) in parallel. The system equations for the AT-configuration of the powertrain model during a parallel CTC gearshift are shown in equation (5), where Iₑ, Iₜ, Iₒ, Iᵥ denote the engine, turbine, transmission output, and vehicle inertias, respectively; Tₑ, Tₚ, Tₜ, Tᵢₙ, T_{off}, Tₒₙ, Tₒ, Tₛ, T_{L} denote the engine, pump, turbine, transmission input, offgoing clutch reaction, oncoming clutch reaction, transmission output, driveshaft, and vehicle load torques, respectively; ωₑ, ωₜ, ωₒ, ωᵥ, ωₒₙ denote the engine, turbine, transmission output, vehicle, and oncoming clutch slip speeds, respectively; Kₛ denotes the lumped driveline compliance, r_{d} (>1) denotes the final drive ratio, a, b, c denote the lever lengths corresponding to a gearshift, say 1-2 upshift. During the parallel CTC gearshift, both the clutches slip while carrying some load. The reaction torques provided by these clutches or the loads carried by the same are equal to their respective clutch torque capacities, which is a function of clutch pressure and clutch friction. The functions f, g represent the torque converter model, and relate pump and turbine speeds to pump and turbine torques.

$${I}_{e} {\dot{ω}}_{e} ( t ) = {T}_{e} ( t ) - {T}_{p} ( t ) \\ {I}_{t} {\dot{ω}}_{t} ( t ) = {T}_{t} ( t ) - {T}_{in} \\ {T}_{p} = f ( {ω}_{e} , {ω}_{t} ) \\ {T}_{t} = g ( {ω}_{e} , {ω}_{t} ) \\ {I}_{o} {\dot{ω}}_{o} ( t ) = {T}_{o} ( t ) - \frac{1}{{r}_{d}} {T}_{s} ( t ) \\ {\dot{T}}_{s} ( t ) = {K}_{s} ( \frac{1}{{r}_{d}} {ω}_{o} ( t ) - {ω}_{v} ( t ) ) \\ {I}_{v} {\dot{ω}}_{v} ( t ) = {T}_{s} ( t ) - {T}_{L} ( t ) \\ {T}_{in} = \frac{b}{a} {T}_{off} + \frac{b + c}{a} {T}_{on} \\ {T}_{o} = \frac{a + b}{a} {T}_{off} ( t ) + \frac{a + b + c}{a} {T}_{on} ( t ) \\ {ω}_{on} = \frac{a + b + c}{a} {ω}_{o} ( t ) - \frac{b + c}{a} {ω}_{t} ( t ) \qquad ( 5 )$$

The method to generate reference trajectories and open-loop control for implementation of parallel CTC for a 1-2 power-on upshift is described first for the DCT-configuration of the powertrain, and later for AT-configuration of the powertrain. In both cases, the free parameter(s), along with the gearshift duration is (are) chosen to satisfy feasibility of the computed solution. In the following, it is assumed that the engine torque is not manipulated during the gearshift, resulting in a near-constant turbine torque. This is done to illustrate a subtle point relating to specifications to be met by a gearshift. The specifications on a gearshift can be divided into two categories: essential and performance. Essential specifications consist of load transfer from the offgoing (11) to the oncoming clutch (10), and speed synchronization of the transmission input speed to the transmission output speed. Depending on the method of controlling the two clutches, the driveshaft torque will have a characteristic variation, which can be improved by engine control to meet certain standards, such as a constant profile during a gearshift. This possibility of shaping of the driveshaft torque, in addition to that achieved by clutch control, leads to certain requirements on the shape of the desired driveshaft torque. These requirements are termed as performance specifications. Such a demarcation is adopted in the simulation studies to illustrate a key feature of parallel CTC gearshifts. It is intuitively clear that if the essential specifications can be met in a way that results in a driveshaft torque profile that is very close to that specified by the performance specification, the burden on engine control would be reduced significantly. Such, in fact, is the case with parallel CTC gearshifts, as will be noted later. This in some sense implies that the engine operates closer to its optimum operating condition as compared to the conventional sequential CTC gearshifts, where engine torque reduction leads to engine operation in relatively inefficient regions. In contrast, if no engine control is required, as would be the case for parallel CTC power-on upshifts if the performance specification is a smoothly decreasing driveshaft torque profile from some initial to the required final value, engine operation is not compromised at all by the need to satisfy a performance specification relating to gearshift quality.

The two kinds of specifications discussed here can be quantified using reference trajectories for two key operating variables—the driveshaft torque trajectory, or more generally the loading element input torque trajectory, and the transmission input acceleration trajectory. In case the transmission is a planetary automatic transmission, the transmission input acceleration trajectory is known as the turbine acceleration trajectory. These trajectories will be specified parametrically, where the parameters will be designed to satisfy certain constraints that will lead to good gearshift quality.

In order to satisfy the performance requirement of a smoothly decreasing driveshaft torque profile during a power-on upshift, and meet the essential specification on load transfer, the following reference trajectory was chosen for the driveshaft torque.

Tₛ(t)=d₃t³+d₂t²+d₁t+d₀, tϵ[0 t_{f}] (6)

where Tₛ denotes the driveshaft torque, the parameters dᵢ, iϵ{0, 1, 2, 3}, are design parameters, and t_{f} is the desired shift duration. More generally, a q^{th} rate of change of the driveshaft torque trajectory can be specified containing m−q output parameters, where 0<q<m, and integrated q times to arrive at the driveshaft torque trajectory containing a total of m output parameters where a remaining q output parameters are obtained as constants of integration. For the method being described here, q=0 and m=4. Simulation will show that such a torque profile can be achieved by clutch control alone in parallel CTC power-on upshifts. Hence, meeting the essential requirement of load transfer from the offgoing (11) to the oncoming clutch (10) during the gearshift leads to satisfaction of the performance specification, thereby eliminating the need for engine control.

The desired driveshaft torque leads to the following wheel angular velocity, or more generally loading element velocity trajectory, for a constant vehicle load torque T_{L} lumped at the powered wheels.

$${ω}_{v} ( t ) = {ω}_{v} ( 0 ) + \frac{1}{{I}_{v}} ( {d}_{3} \frac{{t}^{4}}{4} + {d}_{2} \frac{{t}^{3}}{3} + {d}_{1} \frac{{t}^{2}}{2} + ( {d}_{0} - {T}_{L} ) t ) \qquad ( 7 )$$

The angular velocity of the wheel given by equation (7) is calculated from the vehicle dynamics equation, given by equation (8).

Iᵥ\dot{ω}ᵥ=Tₛ−T_{L} (8)

The transmission output shaft is required to wind up in torsion in order to ensure the desired driveshaft torque Tₛ(t).

$${ω}_{o} ( t ) = \frac{{r}_{d} {d}_{3}}{4 {I}_{v}} {t}^{4} + \frac{{r}_{d} {d}_{2}}{3 {I}_{v}} {t}^{3} + ( \frac{3 {d}_{3} {r}_{d}}{{K}_{s}} + \frac{{r}_{d} {d}_{1}}{2 {I}_{v}} ) {t}^{2} + ( \frac{2 {r}_{d} {d}_{2}}{{K}_{s}} + \frac{{r}_{d}}{{I}_{v}} ( {d}_{0} - {T}_{L} ) ) t + {r}_{d} ( \frac{{d}_{1}}{{K}_{s}} + {ω}_{v}^{0} ) \qquad ( 9 )$$

where ωᵥ⁰:=ωᵥ(0). The transmission output speed trajectory is integrated to give the transmission output position trajectory. The transmission output speed trajectory given by equation (9) is calculated from equation (10), which characterizes the compliance of the driveline.

$${\dot{T}}_{s} = {K}_{s} ( \frac{{ω}_{o}}{{r}_{d}} - {ω}_{v} ) ⇒ {ω}_{o} = {r}_{d} ( \frac{{\dot{T}}_{s}}{{K}_{s}} + {ω}_{v} ) \qquad ( 10 )$$

The transmission output torque (before the final drive) Tₒ required to ensure the desired wind up of the transmission output shaft is given by equation (11).

$${T}_{o} = {I}_{o} {\dot{ω}}_{o} + \frac{{T}_{s}}{{r}_{d}} \qquad ( 11 )$$

where \dot{ω}ₒ is calculated using the expression for ωₒ derived earlier. In (11) \dot{ω}ₒ is the transmission output acceleration trajectory.

The essential specification of speed synchronization is embodied in the following desired transmission input acceleration trajectory, denoted by ωₜ in equation (12).

\dot{ω}ₜ=f₂t²+f₁t+f₀ (12)

where f₂, f₁, f₀ are design parameters. The corresponding transmission input speed trajectory is given by the following equation, which is integrated to give the transmission input position trajectory. More generally, an h^{th} rate of change of the transmission input speed trajectory can be specified containing n−h input parameters, where 0<h<n, and integrated h times to arrive at the transmission input trajectory containing a total of n input parameters where any remaining h input parameters are obtained as constants of integration. For the method being described here, n=4, and h=1. The n−h (=3) parameters in equation (12) are f₂, f₁, and f₀. The fourth parameter results due to integration of equation (12), and appears in as ωₜ⁰ in equation (13), where ωₜ⁰ is initial value of ωₜ. In essence, the fourth parameter satisfies the constraint on initial value of the transmission input speed.

$${ω}_{t} ( t ) = {ω}_{t}^{0} + {f}_{2} \frac{{t}^{3}}{3} + {f}_{1} \frac{{t}^{2}}{2} + {f}_{0} t \qquad ( 13 )$$

As mentioned earlier, the design parameters are calculated to satisfy certain constraints. The first constraint C1 is on the initial value of the driveshaft torque, given by equation (14). For the method being described here, it might be the case that there may be more number of parameters than the number of constraints. In such a case, some parameters should be arbitrarily assigned a numerical value so that the total number of parameters to be solved for equals the total number of constraints to be satisfied. If a parameter can be numerically calculated using any one constraint alone, the parameter cannot be arbitrarily assigned a numerical value, and should be found as part of a solution of the simultaneous system of equations. For instance, since the constraint C1 alone can be used to calculate the value of do, this parameter cannot be assigned a numerical value arbitrarily.

Tₛ(0)=Tₛ⁰=d₀ (14)

The second constraint C2 is on the initial rate of change of the driveshaft torque, which is determined by the wind up of the driveline at start of the gearshift. The second constraint is given by equation (15).

$${\dot{T}}_{s} ( 0 ) = {d}_{1} = {K}_{s} ( \frac{{ω}_{o} ( 0 )}{{r}_{d}} - {ω}_{v} ( 0 ) ) \qquad ( 15 )$$

The parameter d₃ is left as a free variable that can be tuned to ensure some other requirement on the calculated control inputs, such as feasibility, or to increase the spontaneity of the gearshift. It can be verified that the parameter d₃ cannot be determined using any one of the constraints, C1 and C2 described above, and C3, C4, and C6 described below. Hence for the method being described here, with seven parameters and six constraints, d₃ can be arbitrarily assigned a numerical value to make the total number of parameters to be solved for equal to the number of constraints to be satisfied.

The essential constraint on speed synchronization requires that the oncoming clutch slip speed, one of the power transmitting device speed trajectories, is zero at the end of the gearshift, which leads to the third constraint C3 on the gearshift. The third constraint is given by equation (16), where to denotes the time at end of the gearshift. Equation (16) shows the power transmitting device speed trajectory for the oncoming clutch (10).

$${ω}_{on} ( {t}_{f} ) = \frac{a + b + c}{a} {ω}_{o} ( {t}_{f} ) - \frac{b + c}{a} {ω}_{t} ( {t}_{f} ) = 0 ⇒ {ω}_{t}^{f} = \frac{a + b + c}{b + c} {ω}_{o}^{f} \qquad ( 16 )$$

The other essential constraint to be met is on load transfer from the offgoing clutch (11) to the oncoming clutch (10), which can be stated in terms of the following two constraints, C4 and C5, respectively.

Tₒₙ(0)=0, T_{off}(t_{f})=0 (17)

where Tₒₙ and T_{off} are reaction torques provided by the oncoming clutch (10) and offgoing clutch (11), respectively. More generally, these are the power transmitting device torque trajectories for the oncoming (10) clutch and offgoing (11) clutch respectively. Because both the clutches (10, 11) are slipping, the reaction torques are equal to the respective clutch torque capacities T_{on,c},T_{off,c}. For the case under consideration, where the engine torque is constant, in order to satisfy constraints C4 and C5, the final value of the transmission input torque trajectory should be calculated in terms of the transmission input speed trajectory and the constant engine torque. This is done by solving the differential equations representing the engine and the vibration isolation device.

The final constraint that the design parameters need to satisfy is on the acceleration of the oncoming clutch at lock-up. It is desired that the oncoming clutch acceleration is small, ideally zero, for a smooth lock-up. This leads to the constraint C6, given by equation (18), which shows the power transmitting device acceleration trajectory for the oncoming clutch (10).

$${\dot{ω}}_{on} ( {t}_{f} ) = \frac{a + b + c}{a} {\dot{ω}}_{o} ( {t}_{f} ) - \frac{b + c}{a} {\dot{ω}}_{t} ( {t}_{f} ) = 0 \qquad ( 18 )$$

By solving constraints C1-C6 and selecting the free parameter d₃, reference trajectories for the driveshaft torque and the transmission input acceleration can be calculated. Also obtained thus are reference trajectories for the clutch torques and slip speeds, which will be used to derive reference clutch pressures for (open or closed loop) control of the shift hydraulic system, described in the succeeding paragraph.

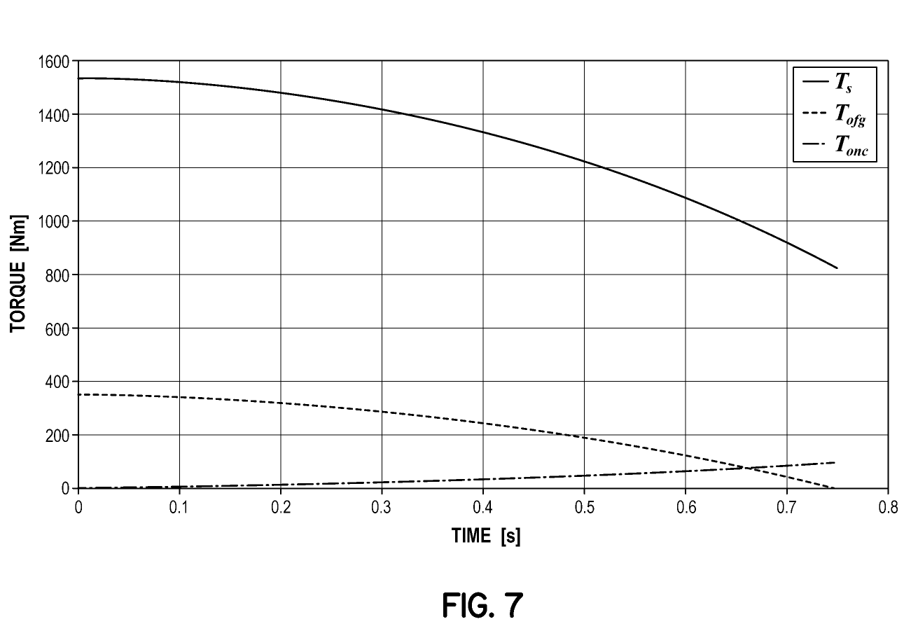

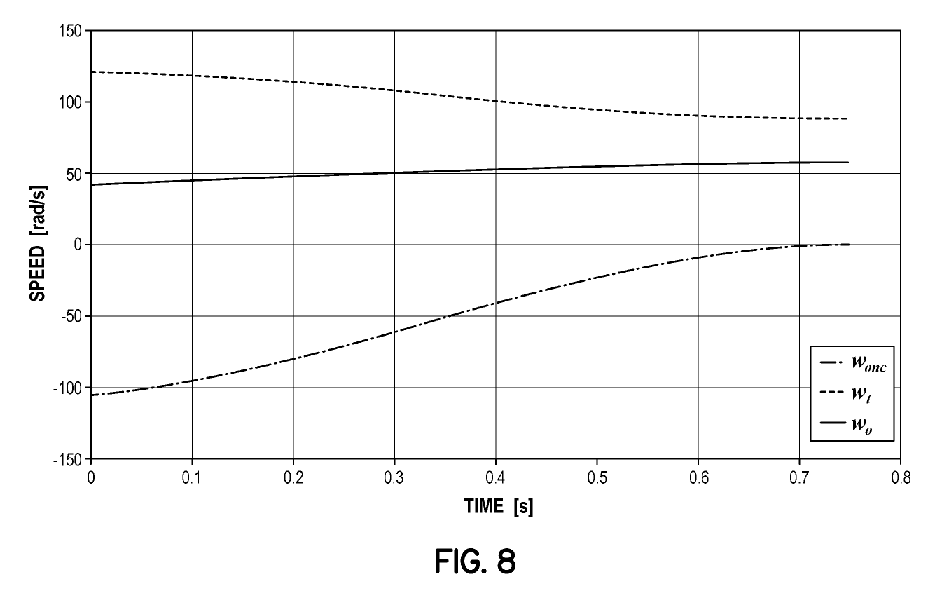

For a DCT type of powertrain having the parameters and gearshift conditions shown in Table 1, the methodology described above is implemented. The free parameter d₃ is chosen from past experience to be −100. The resulting reference trajectories are shown in FIGS. 7 and 8. For the powertrain described by equation (5) in its DCT-configuration, forward simulations were performed as well, using the reference trajectories generated for the clutch and engine torques as inputs to the simulation. The forward simulation predicted the same evolution of system states, the turbine speed and driveshaft torque, as predicted by the open loop control calculation method described earlier.

TABLE 1
System parameters and operating conditions
for a 1-2 power-on upshift

| Symbol | Value | Description |
|---|---|---|
| R₁ | 70 | # teeth on ring gear, input side |
| S₁ | 38 | # teeth on sun gear, input side |
| R₂ | 62 | # teeth on ring gear, reaction side |
| S₂ | 25 | # teeth on sun gear, reaction side |
| r_{d} | 2.84 | Final drive gear ratio |
| Iᵢ | 0.05623 | Turbine inertia [kg - m²] |
| Iₒ | 0.0051057 | Transmission output inertia [kg - m²] |
| M | 1644 | Vehicle mass [kg] |
| r | 0.3214 | Tire radius [m] |
| Kₛ | 7625 | Lumped driveline compliance [Nm/rad/s] |
| Tₜ | 190 | Constant turbine torque corresponding |
| | | to 1-2 upshift [Nm] |
| T_{L} | 24 | Constant load torque corresponding |
| | | to 1-2 upshift [Nm] |
| wᵥ₀ | 15 | Vehicle wheel velocity corresponding |
| | | to 1-2 upshift [rad/s] |
| wₒ₀ | 42.6 | Transmission output velocity at |
| | | t = 0 [rad/s] |
| wₜ₀ | 121.07 | Turbine velocity at |
| | | t = 0 [rad/s] |
| Tₛ₀ | 1533.60 | Value of the driveshaft torque |
| | | at t = 0 [Nm] |

The method described for open loop control and reference trajectory generation for a DCT-type of powertrain can be adapted to an AT-type of powertrain. Due to the presence of a torque converter, the method to generate reference trajectories and open loop control is changed appropriately for the powertrain in its AT-configuration. The methodology is described next. To make the discussion self-contained, certain aspects described above will be repeated.

The desired driveshaft torque is chosen to take the following form, Case 1.

Tₛ(t)=d₃t³+d₂t²+d₁t+d₀, tϵ[0 t_{f}] (19)

### Or, Case 2.

Tₛ(t)=Tₛ(0):=Tₛ⁰, tϵ[0 t_{f}] (20)

which means that a constant driveshaft torque profile is required during the gearshift. More generally, a q^{th} rate of change of the driveshaft torque trajectory can be specified containing m−q output parameters, where 0<q<m, and integrated q times to arrive at the driveshaft torque trajectory containing a total of m output parameters where any remaining q output parameters are obtained as constants of integration. For the method being described here, q=0 and m=4. It should be noted that Case 2 is a special case of Case 1. In order to see this, set d₃=0, d₂=0, and either set d₁, which is equal to the initial value of a first rate of change of the driveshaft torque, equal to zero, or constraint the initial value of the first rate of change of the driveshaft torque to be equal to zero, the two ways are identical. This also means that the same method can be used for both types of the driveshaft torque trajectory. For either of the two cases, the specified driveshaft torque requires the driveline to wind up appropriately. For Case 1, the specified driveshaft torque leads to the following vehicle powered wheel velocity.

$${ω}_{v} ( t ) = {ω}_{v} ( 0 ) + \frac{1}{{I}_{v}} ( {d}_{3} \frac{{t}^{4}}{4} + {d}_{2} \frac{{t}^{3}}{3} + {d}_{1} \frac{{t}^{2}}{2} + ( {d}_{0} - {T}_{L} ) t ) \qquad ( 21 )$$

The wheel velocity given by equation (21) is calculated from the following vehicle dynamics equation.

Iᵥ\dot{ω}ᵥ=Tₛ−T_{L} (22)

In this formulation, the load torque on the vehicle is assumed constant, however, a time varying load torque can also be accommodated in the design procedure. The transmission output shaft is required to wind up in torsion to ensure the desired driveshaft torque. The transmission output shaft speed is given by equation (23), which is calculated from equation (24) that characterizes the driveline compliance behavior.

$${ω}_{o} ( t ) = \frac{{r}_{d} {d}_{3}}{4 {I}_{v}} {t}^{4} + \frac{{r}_{d} {d}_{2}}{3 {I}_{v}} {t}^{3} + ( \frac{3 {d}_{3} {r}_{d}}{{K}_{s}} + \frac{{r}_{d} {d}_{1}}{2 {I}_{v}} ) {t}^{2} + ( \frac{2 {r}_{d} {d}_{2}}{{K}_{s}} + \frac{{r}_{d}}{{I}_{v}} ( {d}_{0} - {T}_{L} ) ) t + {r}_{d} ( \frac{{d}_{1}}{{K}_{s}} + {ω}_{v}^{0} ) \qquad ( 23 )$$

where ωᵥ⁰:=ωᵥ(0).

$${\dot{T}}_{s} = {K}_{s} ( \frac{{ω}_{o}}{{r}_{d}} - {ω}_{v} ) ⇒ {ω}_{o} = {r}_{d} ( \frac{{\dot{T}}_{s}}{{K}_{s}} + {ω}_{v} ) \qquad ( 24 )$$

Similarly, for Case 2, the vehicle wheel and transmission output shaft velocities can be calculated to be the following.

$${ω}_{v} ( t ) = {ω}_{v}^{0} + \frac{1}{{I}_{v}} ( {T}_{s}^{0} - {T}_{L} ) t , ∀ t ∈ [ 0 {t}_{f} ] \\ {\dot{T}}_{s} ( t ) = 0 , ∀ t ∈ [ 0 {t}_{f} ] ⇒ {ω}_{o} ( t ) = {r}_{d} {ω}_{v} ( t ) \qquad ( 25 )$$

The transmission output shaft torque (before the final drive), Tₒ, required to ensure the desired wind up of the transmission output shaft is given by the following equation.

$${T}_{o} = {I}_{o} {\dot{ω}}_{o} + \frac{{T}_{s}}{{r}_{d}} \qquad ( 26 )$$

where \dot{ω}ₒ is calculated using the expression for ωₒ derived in equation (23) and equation (25) for the two cases. The essential specification of speed synchronization is embodied in the following desired transmission input acceleration.

\dot{ω}ₜ=f₂t²+f₁t+f₀ (27)

where f₂, f₁, f₀ are the design parameters. The corresponding turbine speed is given by the following equation. More generally, an h^{th} rate of change of the transmission input speed trajectory can be specified containing n−h input parameters, where 0<h<n, and integrated h times to arrive at the transmission input trajectory containing a total of n input parameters where any remaining h input parameters are obtained as constants of integration. For the method being described, n=4, and h=1. The n−h (=3) parameters in equation (12) are f₂, f₁, and f₀. The fourth parameter results due to integration of equation (12), and appears in as ωₜ⁰ in equation (13), where ωₜ⁰ is initial value of ωₜ. In essence, the fourth parameter satisfies the constraint on initial value of the transmission input speed.

$${ω}_{t} ( t ) = {ω}_{t}^{0} + {f}_{2} \frac{{t}^{3}}{3} + {f}_{1} \frac{{t}^{2}}{2} + {f}_{0} t \qquad ( 28 )$$

The method described here assumes that the engine torque, or more generally the source torque, can be manipulated, implying that the desired driveshaft torque profile specified as part of the performance specification can be allowed to be different from that corresponding to satisfaction of the essential specification. The design parameters in this method are required to satisfy the constraints C1-C5 described earlier. In addition, a new constraint is formulated, C7, which specifies the driveshaft torque value at the end of the gearshift. The parameter d₃ is free to be chosen. The replacement of the constraint C6 by C7 is done to illustrate an advantageous feature of the innovative methodology for gearshift control design. It will be shown that a good gearshift can be obtained by application of the constraint C1-C5, C7, and selection of the free parameter d₃, and any additional free parameter that results due to accommodation of engine and torque converter dynamics in the design method. However, if the specifications become too demanding and the resulting gearshift becomes substandard, in particular due to an abrupt clutch lock-up, the constraint C6 can be invoked to improve gearshift quality. Clearly, an existing degree of freedom in terms of one of the free variables would need to be sacrificed to do so.

The constraint equations C1 and C7 are described in equation (29).

$${T}_{s} ( 0 ) = {T}_{s}^{0} = {d}_{0} \\ {T}_{s} ( {t}_{f} ) = {T}_{s}^{f} = {d}_{3} {t}_{f}^{3} + {d}_{2} {t}_{f}^{2} + {d}_{1} {t}_{f} + {d}_{0} ⇒ {d}_{2} = \frac{1}{{t}_{f}^{2}} ( {T}_{s}^{f} - {d}_{3} {t}_{f}^{3} - {d}_{1} {t}_{f} - {d}_{0} ) \qquad ( 29 )$$

The second constraint C2 is on the initial rate of change of the driveshaft torque, which is determined by the wind up of the driveline at start of the gearshift. The constraint C2 is given by equation (30).

$${\dot{T}}_{s} ( 0 ) = {d}_{1} = {K}_{s} ( \frac{{ω}_{o} ( 0 )}{{r}_{d}} - {ω}_{v} ( 0 ) ) \qquad ( 30 )$$

As mentioned earlier, the parameter d₃ is a free variable that can be tuned to ensure some requirements on the gearshift. Once d₃ is chosen, the velocity of the transmission output shaft at t=t_{f}, ωₒ(t_{f}):=ωₒ^{f} gets fixed, and is known numerically. Once ωₒ^{f} is calculated for both the cases, the condition on the final value of the turbine speed ωₜ(t_{f}):=ωₜ^{f} can be derived in order to accomplish speed synchronization. The condition for speed synchronization, constraint C3, is given by equation (31).

$${ω}_{on} ( {t}_{f} ) = \frac{a + b + c}{a} {ω}_{o} ( {t}_{f} ) - \frac{b + c}{a} {ω}_{t} ( {t}_{f} ) = 0 ⇒ {ω}_{t}^{f} = \frac{a + b + c}{b + c} {ω}_{o}^{f} \qquad ( 31 )$$

The other essential constraint to be met is on load transfer from the offgoing clutch (11) to the oncoming clutch (10), which can be stated in terms of the following two constraints, C4 and C5.

Tₒₙ(0)=0,T_{off}(t_{f})=0 (32)

where Tₒₙ and T_{off} are reaction torques of the oncoming clutch (10) and offgoing clutch (11), respectively. Because both the clutches are slipping, the reaction torques are equal to the respective clutch torque capacities, T_{on,c},T_{off,c}. For the case when engine torque is constant (not discussed in this application), in order to satisfy constraints C4 and C5, final value of the transmission input torque trajectory should be calculated in terms of the transmission input speed trajectory and the constant engine torque. This is done by solving the differential equations representing the engine and the torque converter.

Using the lever diagram, it can be shown that

$$[ \begin{matrix}{T}_{off , c} \\ {T}_{on , c}\end{matrix} ] = [ \begin{matrix}{a}_{11} & {a}_{12} \\ {a}_{21} & {a}_{22}\end{matrix} ] [ \begin{matrix}{I}_{o} {\dot{ω}}_{o} + \frac{{T}_{s}}{{r}_{d}} \\ {T}_{t} - {I}_{t} {\dot{ω}}_{t}\end{matrix} ] \qquad ( 33 )$$

The initial and final value of the turbine acceleration, \dot{ω}ₜ⁰ and \dot{ω}ₜ^{f}, can be designed to ensure the specification on load transfer. Note that the initial and final values of \dot{ω}^{o} and T have already been fixed. Similarly, the initial value of the turbine torque gets fixed by the starting conditions of the gearshift, but its final value is still a design variable that is free, and will be designed to eliminate driveline oscillations excited by the clutch lock-up. The following constraint equations need to be satisfied simultaneously, along with equation (31).

$$\begin{matrix}{\dot{ω}}_{t}^{0} = {f}_{0} \\ {\dot{ω}}_{t}^{f} = {f}_{2} {t}_{f}^{2} + {f}_{1} {t}_{f} + {f}_{0} & ( 34 ) \\ {ω}_{t}^{f} = {ω}_{t}^{0} + {f}_{2} \frac{{t}_{f}^{3}}{3} + {f}_{1} \frac{{t}_{f}^{2}}{2} + {f}_{0} {t}_{f} & ( 35 )\end{matrix}$$

The solution to equations (34) and (35) determines the turbine speed trajectory in equation (28). In order to calculate the clutch torque capacities, one needs to know how the turbine torque Tₜ changes during the gearshift. Towards this end, one can use a torque converter model, such as the one described in equation (5), to evaluate Tₜ in terms of turbine and engine speeds. This implies that the engine acceleration can be specified to control the turbine torque during the gearshift. The desired engine acceleration \dot{ω}ₑ may be denoted parametrically in terms of the design parameters e₂, e₁ and e₀.

\dot{ω}ₑ=e₂t²+e₁t+e₀, ∀tϵ[0 t_{f}] (36)

One way to decide upon the design parameters is to let the engine acceleration at t=0 be determined as follows.

$${\dot{ω}}_{e} ( 0 ) = \frac{1}{{I}_{e}} ( {T}_{e} ( 0 ) - {T}_{p} ( 0 ) ) = {e}_{0} \qquad ( 37 )$$

Let e₂ be a free parameter, like d₃, that can be tuned to further optimize the results. The parameter e₁ can be chosen to ensure a desired specification on engine acceleration at t=t_{f}, \dot{ω}ₑ(t_{f}):=ωₑ^{f}. One particular choice would be to ensure zero acceleration of the engine inertia at t=t_{f}.

$${e}_{1} = \frac{1}{{t}_{f}} ( {\dot{ω}}_{e}^{f} - {e}_{2} {t}_{f}^{2} - {e}_{0} ) \qquad ( 38 )$$

In this way, the design parameters e₂, e₁ and e₀ can be calculated. By using these design parameters, one can calculate the engine speed ωₑ, or more generally the source speed

$${ω}_{e} ( t ) = {ω}_{e}^{0} + {e}_{2} \frac{{t}^{3}}{3} + {e}_{1} \frac{{t}^{2}}{2} + {e}_{0} t , t ∈ [ 0 {t}_{f} ] \qquad ( 39 )$$

Using the torque converter model, one can calculate the pump and turbine torques during the gearshift. Once the turbine torque has been calculated, the clutch capacities can be back-calculated using equation (33). Also, using the desired engine acceleration equation (36) and the calculated pump torque, one can calculate the required engine torque Tₑ by using the following engine model equation.

Tₑ(t)=Iₑ\dot{ω}ₑ(t)+Tₚ(t), tϵ[0 t_{f}] (40)

The methodology for calculating reference trajectories and corresponding control inputs described above was applied to a 1-2 power-on upshift for a powertrain in AT-configuration. The powertrain comprises the engine, torque converter, gearbox, driveline compliance, final drive, and vehicle inertia. The two clutch torque capacities and engine torque were assumed to be control inputs. The parameters for the powertrain model are same as those shown in Table 1, and operating conditions corresponding to the 1-2 power-on upshift are shown in Table 2.

TABLE 2
Operating conditions for a 1-2 power-on upshift

| | | |
|---|---|---|
| wᵥ⁰ | 27.68 | rad/s |
| wₜ⁰ | 223.41 | rad/s |
| wₑ⁰ | 261.60 | rad/s |
| Tₑ⁰ | 150 | Nm |
| T_{L} | 24 | Nm |
| t_{f} | 1 | s |
| Tₛ⁰ | 1054.5 | Nm |
| Tₛ^{f} | 0.4 | Tₛ⁰ |

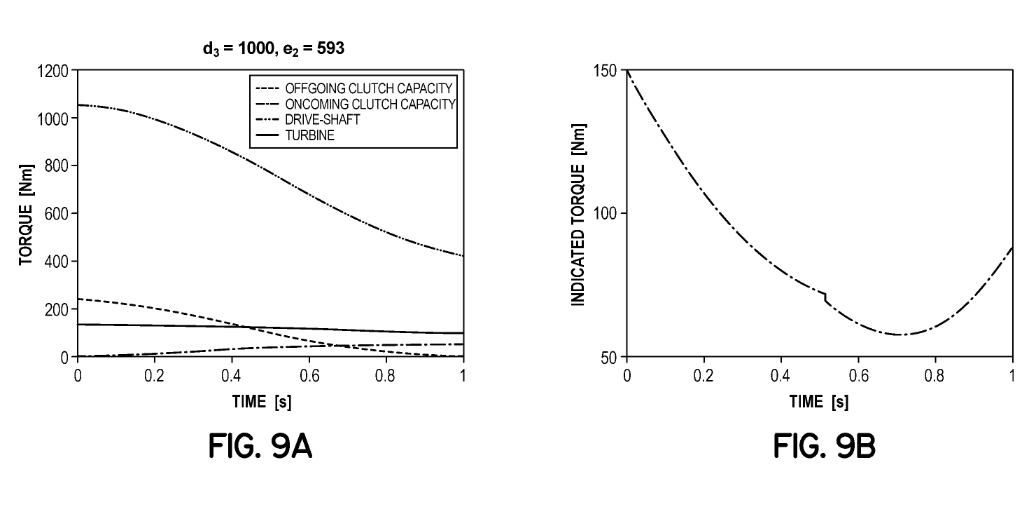

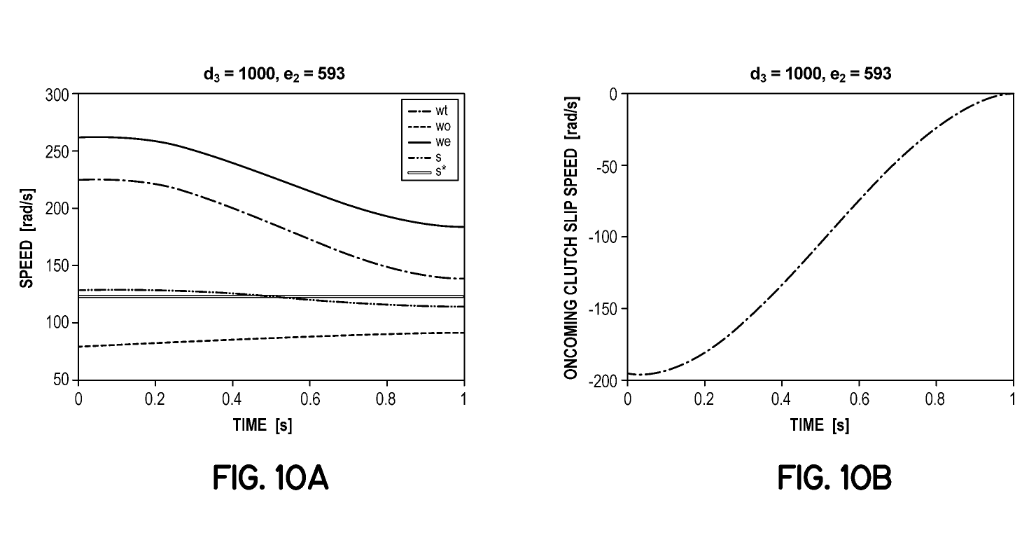

The algorithm to calculate reference trajectories and control inputs for implementation of a parallel CTC gearshift, described earlier, is used to calculate the trajectories shown in FIGS. 9A-10B. The two free parameters are chosen to be d₃=1000, e₂=593. Specifying e₂ here amounts to numerically specifying the engine acceleration or first rate of change of engine speed.

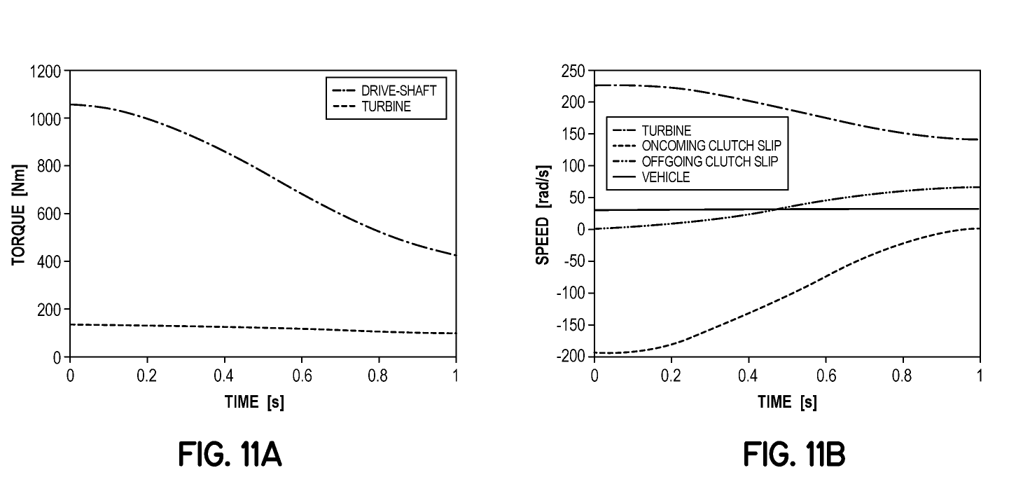

The forward simulation of the powertrain described earlier was performed to implement open-loop control of parallel CTC gearshift. Control inputs to this simulation were the clutch torques and the engine indicated torque, shown in FIGS. 9A, 9B. The results of the forward simulation are shown in FIGS. 11A, 11B.

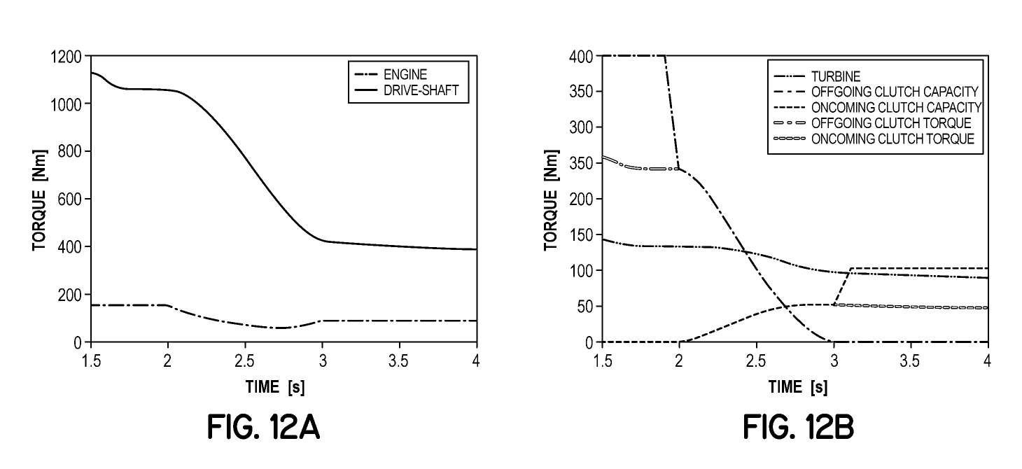

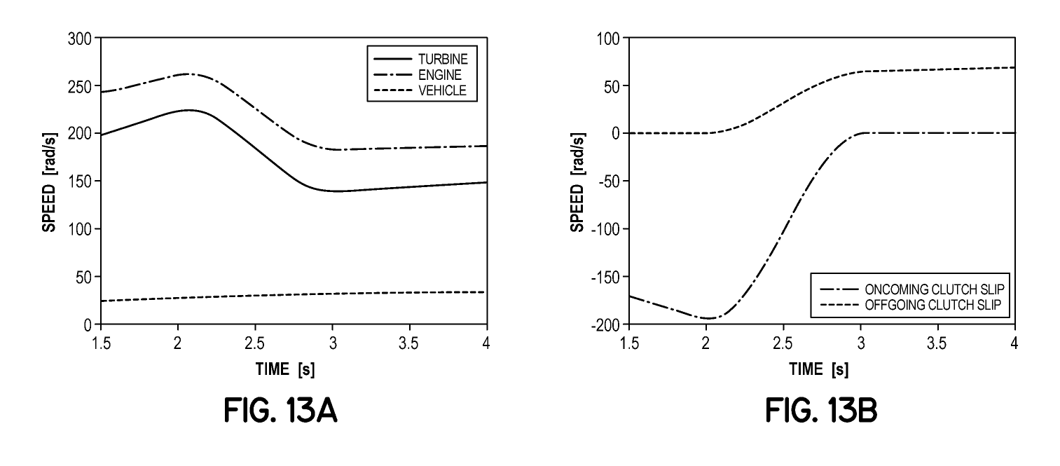

A simulation was also performed that included both the first and second gear phases along with the gearshift. The shift was commanded at 2 s. The results of the simulation are shown in FIGS. 12A-13B. It can be clearly seen that the driveline is not excited due to clutch lock-up, implying a smooth gearshift.

A simple hydraulic model was added to the simulation in order to validate the parallel CTC gearshift on a complete powertrain model. A first order linear model was used to model the clutch actuation system, P_{c} and i_{c} denote the clutch pressure and the input current, respectively, and τ_{c} and K_{c} are model parameters.

$${\dot{P}}_{c} = \frac{1}{{τ}_{c}} ( - {P}_{c} + {K}_{c} i ) \qquad ( 41 )$$

The friction characteristics for both the offgoing clutch (11) and oncoming clutch (10) were assumed to be representative of new clutches. A PID controller was designed for the clutch actuation system, and the desired clutch pressure references were derived from the respective desired clutch torque capacities using the definition of torque capacity given by equation (42).

T_{c}=A_{c}R_{c}N_{c}μ(Δω_{c})P_{c} (42)

where A_{c}, N_{c}, R_{c} denote geometric parameters of the clutch, and μ represents the clutch friction coefficient that is function of the clutch slip velocity Δω_{c}.

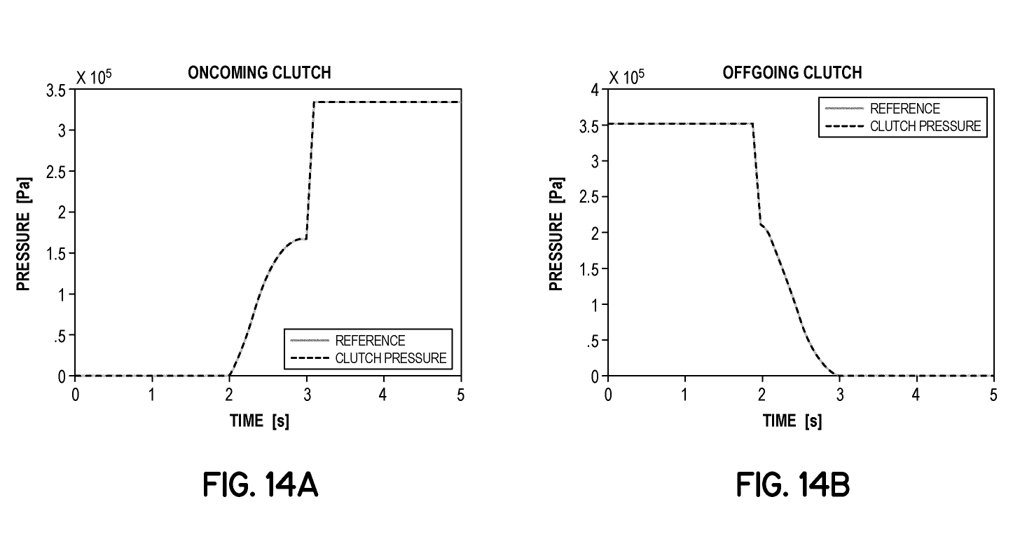

Corresponding to the clutch torque capacities shown in FIGS. 12A, 12B, the reference and tracked clutch pressures are shown in FIGS. 14A, 14B, where the observed excellent clutch pressure tracking is a consequence of the simple hydraulic model and the assumption of known clutch friction characteristics.

The method described for planetary automatic transmissions with engine torque as a control variable can be transformed for dual clutch transmissions. The required modification is calculating the pump and turbine torques using the torque converter model. This step for dual clutch transmission is modified as follows: the vibration isolation device input torque (counterpart of pump torque) and the transmission input torque (counter part of turbine torque) should be calculated using a vibration isolation device model which, depending on its make, might require, in addition to the source speed and the transmission input speed, their respective position trajectories as well.

The proposed algorithm was also applied to the powertrain described in equation (5) in its AT-configuration, but this time with the intent of maintaining a constant driveshaft torque at the vehicle powered wheels. The operating conditions for the gearshift are shown in Table 3.

TABLE 3
Operating conditions for a 1-2 power-on upshift

| | | |
|---|---|---|
| wᵥ⁰ | 27.68 | rad/s |
| wₜ⁰ | 223.41 | rad/s |
| wₑ⁰ | 261.60 | rad/s |
| Tₑ⁰ | 150 | Nm |
| T_{L} | 24 | Nm |
| t_{f} | 1 | s |
| Tₛ⁰ | 1054.5 | Nm |

| | |
|---|---|
| Tₛ^{f} | Tₛ⁰ |

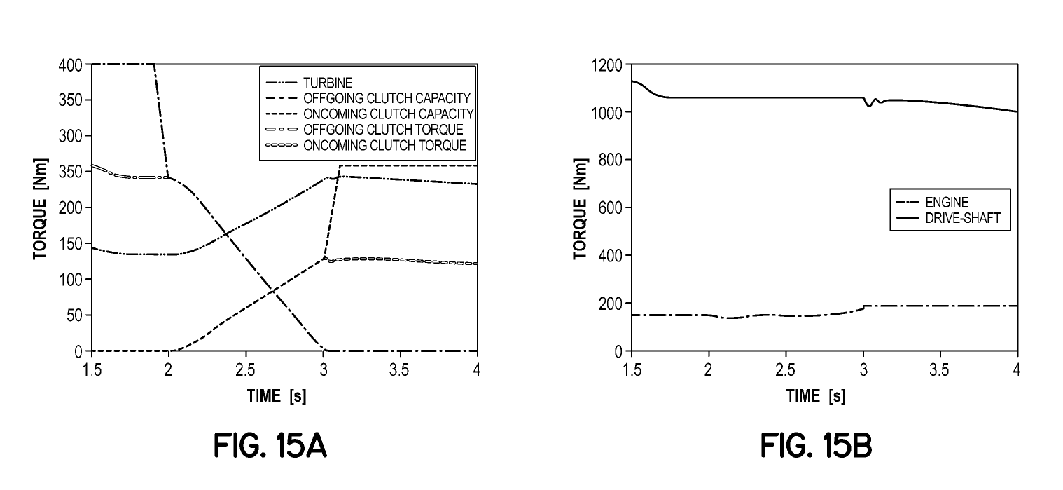

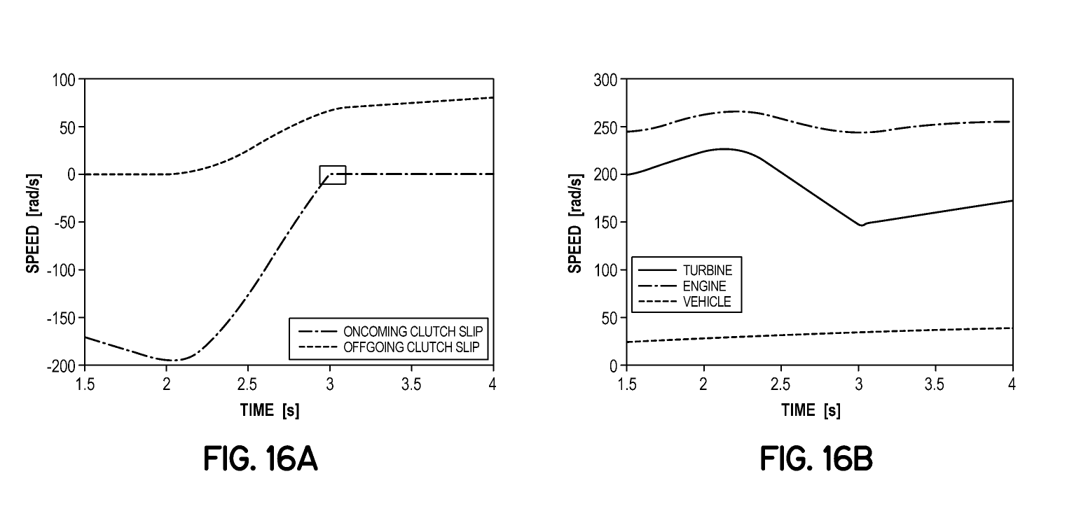

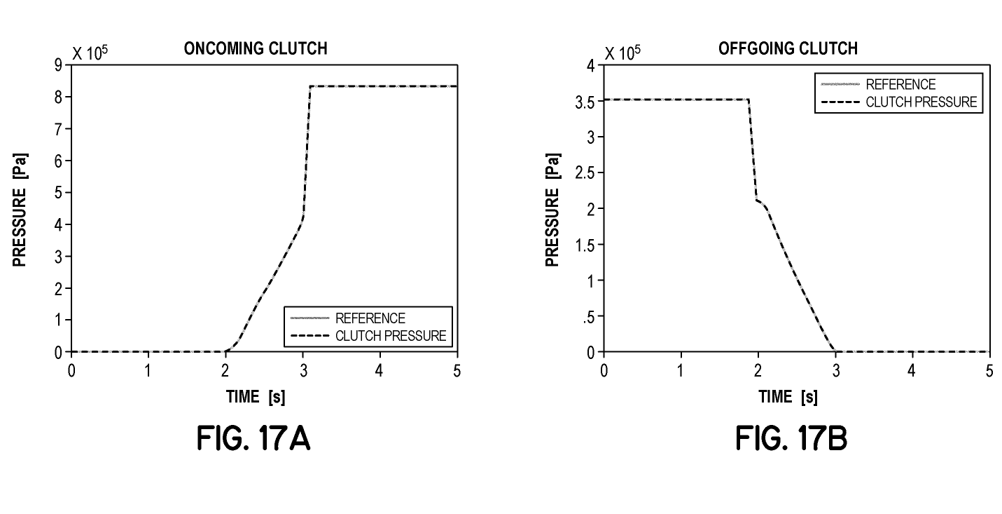

Following the design procedure described earlier, the desired trajectories of the clutch and engine torques were designed and implemented in the simulation, the results of which are shown in FIGS. 15A-16B. The performance of the clutch pressure control system is shown in FIGS. 17A, 17B. The gearshift occurs between 2 and 3 s, and it can be noticed that the driveshaft torque remains constant throughout this duration. However, once the oncoming clutch (10) locks-up, the driveline gets excited and oscillations are seen. The reason for driveline oscillations is abrupt clutch-lock up, i.e., very high oncoming clutch slip deceleration, see FIG. 16A at t=3 s. In order to eliminate the driveline oscillations, one needs to design open-loop controls such that the oncoming clutch slip acceleration is close to zero at clutch lock-up.

The oncoming clutch slip acceleration during the gearshift is given by equation (43).

$${\dot{ω}}_{on} ( t ) = \frac{a + b + c}{a} {\dot{ω}}_{o} ( t ) - \frac{b + c}{a} {\dot{ω}}_{t} ( t ) \qquad ( 43 )$$

Thus, one needs to ensure the following in order to ensure a smooth lock-up.

$${\dot{ω}}_{o} ( {t}_{f} ) = \frac{b + c}{a + b + c} {\dot{ω}}_{t} ( {t}_{f} ) \qquad ( 44 )$$

It was shown earlier that the following condition should hold

$${\dot{ω}}_{t} ( {t}_{f} ) = \frac{1}{{I}_{t} {a}_{12}} ( {a}_{12} {T}_{t} ( {t}_{f} ) + {a}_{11} ( {I}_{o} {\dot{ω}}_{o} ( {t}_{f} ) + \frac{{T}_{s}^{f}}{{r}_{d}} ) ) \qquad ( 45 )$$

for complete load transfer from the offgoing clutch (11) to the oncoming clutch (10). Using equations (44) and (45), the value of turbine torque that can accomplish zero oncoming clutch slip acceleration at clutch lock-up can be found. This desired turbine torque can be achieved by controlling engine speed, as was described in the paragraphs [0032]-[0034], which amounts to ensuring equation (46).

Tₜ^{f}=a₂ωₑ*(t_{f})²+a₁ωₑ*(t_{f})ωₜ(t_{f})+a₀ωₜ(t_{f})² (46)

In equation (46), a₂, a₁, a₀ are torque converter model parameters, ωₜ(t_{f}) is known from the speed synchronization condition, see equation (31). Thus, equation (46) is quadratic in the unknown ωₑ*(t_{f}), i.e., the desired final engine velocity, and can be easily solved for. It was found that only one root made physical sense, and hence was used for design. In order to achieve this desired final engine speed, the engine acceleration will be appropriately shaped. Recall that in the procedure described earlier, the final value of engine acceleration was arbitrarily selected to be zero. Instead, this degree of freedom will be used to ensure the desired final velocity of engine speed, which is shown in equation (47).

$${ω}_{e}^{f} = {ω}_{e} * ( {t}_{f} ) = {ω}_{e}^{0} + {e}_{2} \frac{{t}_{f}^{3}}{3} + {e}_{1} \frac{{t}_{f}^{2}}{2} + {e}_{0} {t}_{f} ⇒ {e}_{1} = \frac{2}{{t}_{f}^{2}} ( {ω}_{e}^{f} - {ω}_{e}^{0} - {e}_{2} \frac{{t}_{f}^{3}}{3} - {e}_{0} {t}_{f} ) \qquad ( 47 )$$

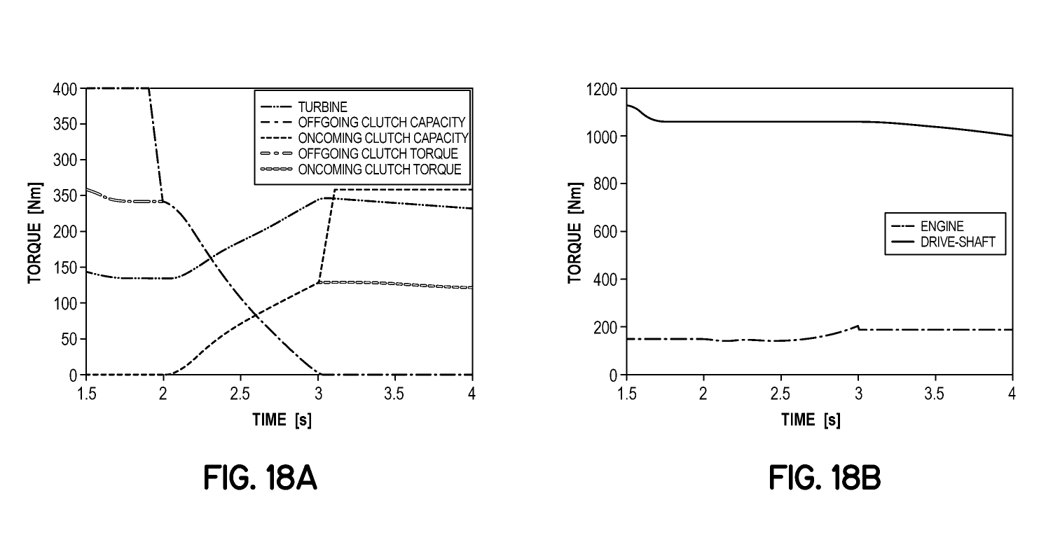

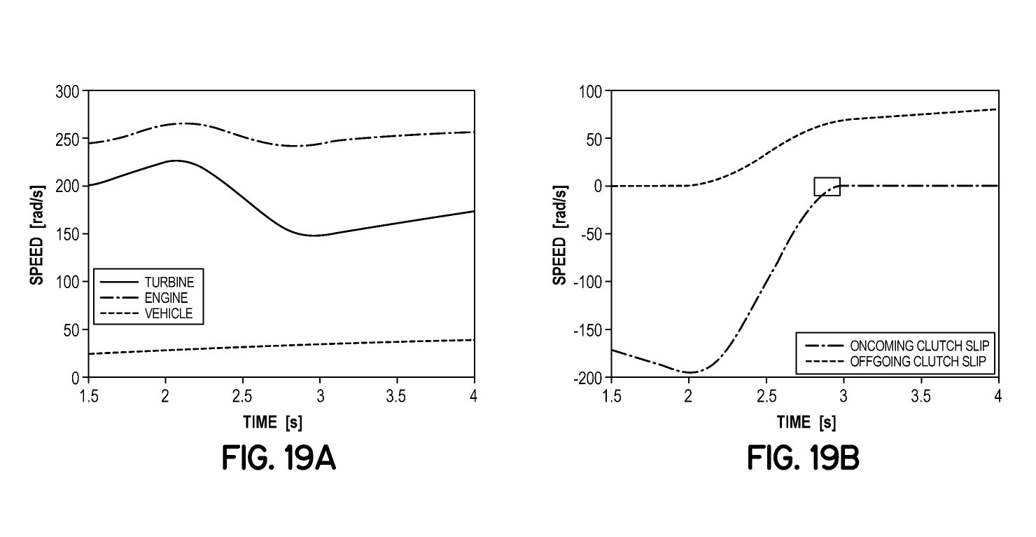

A simulation of the parallel CTC gearshift for the operating conditions specified by Table 3, and with reference clutch pressures for closed-loop clutch pressure control calculated using the modified design procedure was performed. Results are shown in FIGS. 18A-19B. It can be clearly seen from these figures that ensuring small oncoming clutch slip acceleration at the clutch lock-up reduces the driveline oscillations to very low levels.

The method proposed through this invention has a degree of modularity to it in the following sense. The design method can easily incorporate different number of constraints in order to calculate clutch and engine torque trajectories, which when implemented provide the desired gearshift response. For example, starting with the driveshaft and transmission input speed trajectories with m output and n input parameters respectively, one can design the torque trajectories of interest by satisfying p constraints, where p is a positive integer. If m+n>p, which generally will be the case, one needs to arbitrarily assign numerical values to m+n−p parameters so that the total number of parameters to be solved for equals the total number of constraints to be satisfied. Using this design method as the starting point, if one wishes to incorporate k more constraints, k being a positive integer, k more parameters must be available to solve for (p+k) constraints, noting that all the constraints must be simultaneously satisfied. This is easily achieved by unassigning numerical values for k parameters out of the already assigned m+n−p parameters, making the total number of parameters to be solved for equal to (p+k).

The algorithm described above for both dual clutch and planetary automatic transmissions assumes that the clutches are completely filled with transmission oil and are ready to transfer power at the start of the gearshift. For current vehicles and the road transportation system, this assumption is true for power-on upshifts and power-off downshifts, but not for power-on downshifts, sometimes known as kick-down downshift, and power-off upshifts. For these gearshifts, it is not possible to fill the oncoming clutch with transmission oil before the start of the gearshift because of the need for spontaneity of powertrain response to the driver's demand, which are unpredictable.

Kick-down downshifts and power-off upshifts arise for a few reasons: 1) the driver presses the accelerator pedal hard in order to accommodate increased load on the vehicle, such as during an uphill motion, or to accelerate rapidly in an emergency situation, both situations requiring a power-on downshift; 2) the driver rapidly releases the accelerator pedal from its nearly fully depressed position expecting reduced acceleration or vehicle load, resulting in a power-off upshift. In either of these two situations, for good drivability a quick response from the powertrain is expected, implying that these shifts need to be initiated as soon as the request is made. This further implies that the oncoming clutch involved in these gearshifts cannot be assumed to be filled with transmission oil at the start of the gearshift. For these types of gearshifts, the gearshift should be initiated and controlled using current clutch-to-clutch shift practice. The inertia phase is initiated first in current practice in such situations, along with simultaneously initiation of filling of the oncoming clutch. As soon as the oncoming clutch is completely filled with transmission oil, the gearshift should be controlled to perform load transfer and the remaining speed synchronization in parallel. Towards this end, the model given by equation (5) would be modified to include the control of the initial part of the gearshifts of interest using current practice, and then applying the constraints required for good gearshift quality in order to calculate control inputs. The only constraints that need to change then are on the initial value of the driveshaft torque and its derivative, the constraints C1 and C2. These quantities need to be constrained using the values of driveshaft torque and its derivative at the end of the oncoming clutch fill phase, which can be obtained using the modified model. All other constraints remain the same. The resulting control inputs will be used to control the load transfer and speed synchronization in parallel after the oncoming clutch fill phase is complete.

The open loop control methodology is best used in conjunction with feedback control laws which ensure robust implementation of the control. A closed loop implementation of the simultaneous speed synchronization and load transfer strategy for a clutch-to-clutch shift is outlined in FIG. 6. The closed loop controller comprises a combination of a reference clutch pressure generator (73) and a clutch pressure controller (74). The desired transmission input shaft speed trajectory and the desired output shaft torque trajectory (72) are supplied to the reference clutch pressure generator (73), which provides the reference trajectories for the clutch pressure controller (74). The outputs of the clutch pressure controller block are the commands (36, 37) to the clutch pressure control system (75), which comprises solenoid valves (26, 31), pressure control valves (27, 32), and clutch-accumulator chambers (28, 33). The clutch pressures (12, 13) generated by the clutch pressure control systems operate the offgoing clutch (11) and oncoming clutch (10) in the transmission mechanical system (76). The clutch pressure controller (74), and the reference generator (73), require information about various unmeasured variables: clutch pressures, output shaft torque, turbine torque, and reaction torques at the offgoing and the oncoming clutches. The required information is estimated by an on-line observer (77), which uses the measured angular speeds (22, 23, 24, 25) and calculates the required variables.

While the present invention has been illustrated by the description of specific embodiments thereof, and while these embodiments have been described in considerable detail, they are not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

What is claimed is:

1. A method for simultaneously controlling transfer of load and synchronization of speed between actively controlled power transmitting devices during a gearshift in a stepped automatic transmission connected to a loading element, and acted upon by a transmission input torque trajectory, the method comprising:
specifying an h^{th} rate of change of a transmission input speed trajectory having n−h input parameters, where h is a nonnegative integer, n is a positive integer, and n−h>0;
when h>0, integrating the h^{th} rate of change of the transmission input speed trajectory h times to calculate the transmission input speed trajectory and remaining h input parameters as constants of integration, so that a total number of input parameters associated with the transmission input speed trajectory is n;
specifying a q^{th} rate of change of a loading element input torque trajectory having m−q output parameters, where q is a nonnegative integer, m is a positive integer, and m−q>0;
when q>0, integrating the q^{th} rate of change of the loading element input torque trajectory q times to calculate the loading element input torque trajectory and remaining q output parameters as constants of integration, so that a total number of output parameters associated with the loading element input torque trajectory is m;
calculating a loading element velocity trajectory based on the loading element input torque trajectory;
calculating a transmission output speed trajectory based on the loading element input torque trajectory and the loading element velocity trajectory;
differentiating the transmission output speed trajectory to calculate a transmission output acceleration trajectory;
calculating a power transmitting device torque trajectory for each of the transmitting devices based on the transmission output acceleration trajectory, the loading element input torque trajectory, a transmission input acceleration trajectory, and the transmission input torque trajectory;
calculating a power transmitting device speed trajectory for each of the transmitting devices based on the transmission input speed trajectory and the transmission output speed trajectory;
assigning numerical values to a subset of the n input and m output parameters, the subset including m+n−p parameters, where p is a nonnegative integer less than m+n;
calculating numerical values for remaining p parameters, which were not included in the subset of n input and m output parameters receiving assigned numerical values, by satisfying p constraints on initial values of the loading element input torque trajectory, the first rate of change of the loading element input torque trajectory with respect to time, initial value of the transmission input speed trajectory, and initial and final values of the torque and speed trajectories of selected power transmitting devices;
calculating the torque and speed trajectories of the power transmitting devices using the numerical values of the m+n parameters; and
controlling the power transmitting devices in a manner prescribed by the torque and speed trajectories during a gearshift.

2. The method of claim 1, further comprises:
differentiating the power transmitting device speed trajectory for selected power transmitting devices to calculate a power transmitting device acceleration trajectory for the selected power transmitting devices;
unassigning numerical values for k parameters, where k is a positive integer and p+k<m+n; and
wherein the step of calculating numerical values further includes calculating numerical values for k more parameters by satisfying k more constraints on initial and final values of power transmitting device acceleration trajectories for the selected power transmitting devices.

3. The method of claim 1 wherein the loading element is an automotive vehicle, the stepped automatic transmission is a dual clutch transmission, the power transmitting devices are clutches, and a constant source torque produced by an internal combustion engine, another prime mover, or a combination thereof is transmitted by a vibration isolation device to produce a transmission input torque, and the method further comprises:
calculating the transmission input torque trajectory based on the transmission input speed trajectory and the source torque.

4. The method of claim 1 wherein the loading element is an automotive vehicle, the stepped automatic transmission is a planetary automatic transmission, the power transmitting devices are clutches, and a constant source torque produced by an internal combustion engine, another prime mover, or a combination thereof is transmitted by a torque converter to produce a transmission input torque, and the method further comprises:
calculating the transmission input torque trajectory based on the transmission input speed trajectory and the source torque.

5. The method of claim 1 wherein the loading element is an automotive vehicle, the stepped automatic transmission is a dual clutch transmission, the power transmitting devices are clutches, and a source torque produced by a power source is transmitted by a vibration isolation device to produce a transmission input torque, the method further comprises:
specifying a r^{th} rate of change of a source speed trajectory, where r is a nonnegative integer;
if r>0, integrating the r^{th} rate of change of the source speed trajectory r times to calculate the source speed trajectory and r+1 times to calculate a source position trajectory;
unassigning numerical values for m-4 parameters out of the already assigned m+n−p parameters, and assigning numerical values to a subset of the m output parameters, the subset including m-3 parameters;
integrating the transmission output speed trajectory to calculate a transmission output position trajectory;
calculating a final value of the transmission output position trajectory;
calculating a final value of the transmission output speed trajectory;
calculating a final value of the transmission input speed trajectory based on a current gear ratio and the final value of the transmission output speed trajectory;
calculating a final value of the transmission input position trajectory based on the current gear ratio and the final value of the transmission output position trajectory;
calculating a final value of the transmission input torque trajectory based on the final value of the source position trajectory, the source speed trajectory, the transmission input speed trajectory, and the transmission input position trajectory;
wherein the step of calculating numerical values further includes calculating a numerical value of one more parameter by satisfying an additional constraint on final value of the driveshaft torque trajectory;
calculating a vibration isolation device input torque trajectory based on the source position trajectory, the source speed trajectory, the transmission input speed trajectory, and the transmission input position trajectory;
calculating a source torque trajectory based on the source speed trajectory and the vibration isolation device input torque trajectory; and
controlling the power source in a manner prescribed by the source torque trajectory and the source speed trajectory during a gearshift.

6. The method of claim 1 wherein the loading element is an automotive vehicle, the stepped automatic transmission is a planetary automatic transmission, the power transmitting devices are clutches, and a source torque produced by power source is transmitted by a torque converter to produce a transmission input torque, the method further comprises:
specifying a r^{th} rate of change of a source speed trajectory, where r is a nonnegative integer;
if r>0, integrating the r^{th} rate of change of the source speed trajectory r times to calculate the source speed trajectory;
unassigning numerical values for m-4 parameters out of the already assigned m+n−p parameters, and assigning numerical values to a subset of the m output parameters, the subset including m-3 parameters;
calculating a final value of the transmission output speed trajectory;
calculating a final value of the transmission input speed trajectory based on a current gear ratio and the final value of the transmission output speed trajectory;
calculating a final value of the transmission input torque trajectory based on the final value of the source speed trajectory and the transmission input speed trajectory;
wherein the step of calculating numerical values further includes calculating a numerical value of one more parameter by satisfying an additional constraint on final value of the driveshaft torque trajectory;
calculating a torque converter input torque trajectory based on the source speed trajectory and the transmission input speed trajectory;
calculating a source torque trajectory using the source speed trajectory and the torque converter input torque trajectory; and
controlling the power source in a manner prescribed by the source torque trajectory and the source speed trajectory during a gearshift.

7. The method of claim 3, wherein the clutches are hydraulically powered, the hydraulically powered clutches being controllable by commanding solenoid valves, and the method further comprises:
calculating reference clutch pressure trajectories by using the power transmitting device torque trajectories;
calculating commands for the solenoid valves based on the reference clutch pressure trajectories, and controlling the solenoid valves in a manner specified by these calculate commands.

8. The method of claim 4, wherein the clutches are hydraulically powered, the hydraulically powered clutches being controllable by commanding solenoid valves, and the method further comprises:
calculating reference clutch pressure trajectories by using the power transmitting device torque trajectories;
calculating commands for the solenoid valves based on the reference clutch pressure trajectories, and controlling the solenoid valves in a manner specified by these calculate commands.

9. The method of claim 5, wherein the clutches are hydraulically powered, the hydraulically powered clutches being controllable by commanding solenoid valves, and the method further comprises:
calculating reference clutch pressure trajectories by using the power transmitting device torque trajectories;
calculating commands for the solenoid valves based on the reference clutch pressure trajectories, and controlling the solenoid valves in a manner specified by these calculate commands.

10. The method of claim 6, wherein the clutches are hydraulically powered, the hydraulically powered clutches being controllable by commanding solenoid valves, and the method further comprises:
calculating reference clutch pressure trajectories by using the power transmitting device torque trajectories;
calculating commands for the solenoid valves based on the reference clutch pressure trajectories, and controlling the solenoid valves in a manner specified by these calculate commands.

11. The method of claim 3, wherein the clutches are hydraulically powered and are controlled by commanding solenoid valves, the solenoid valves being controllable by a feedback controller having a set of feedback controller gains, and the method further comprises:
calculating reference clutch pressure trajectories based on the power transmitting device torque trajectories;
calculating the set of feedback controller gains to track the reference clutch pressure trajectories, and controlling the solenoid valves in a manner specified by this set of feedback controller gains.

12. The method of claim 4, wherein the clutches are hydraulically powered and are controlled by commanding solenoid valves, the solenoid valves being controllable by a feedback controller having a set of feedback controller gains, and the method further comprises:
calculating reference clutch pressure trajectories based on the power transmitting device torque trajectories;
calculating the set of feedback controller gains to track the reference clutch pressure trajectories, and controlling the solenoid valves in a manner specified by this set of feedback controller gains.

13. The method of claim 5, wherein the clutches are hydraulically powered and are controlled by commanding solenoid valves, the solenoid valves being controllable by a feedback controller having a set of feedback controller gains, and the method further comprises:
calculating reference clutch pressure trajectories based on the power transmitting device torque trajectories;
calculating the set of feedback controller gains to track the reference clutch pressure trajectories, and controlling the solenoid valves in a manner specified by this set of feedback controller gains.

14. The method of claim 6, wherein the clutches are hydraulically powered and are controlled by commanding solenoid valves, the solenoid valves being controllable by a feedback controller having a set of feedback controller gains, and the method further comprises:
calculating reference clutch pressure trajectories based on the power transmitting device torque trajectories;
calculating the set of feedback controller gains to track the reference clutch pressure trajectories, and controlling the solenoid valves in a manner specified by this set of feedback controller gains.

15. A controller for simultaneously controlling transfer of load and synchronization of speed between actively controlled power transmitting devices during a gearshift in a stepped automatic transmission connected to a loading element, and acted upon by a transmission input torque trajectory, the controller configured to:
specify an h^{th} rate of change of a transmission input speed trajectory having n−h input parameters, where h is a nonnegative integer, n is a positive integer, and n−h>0;
when h>0, integrate the h^{th} rate of change of the transmission input speed trajectory h times to calculate the transmission input speed trajectory and remaining h input parameters as constants of integration, so that a total number of input parameters associated with the transmission input speed trajectory is n;
specify a q^{th} rate of change of a loading element input torque trajectory having m−q output parameters, where q is a nonnegative integer, m is a positive integer, and m−q>0;
when q>0, integrate the q^{th} rate of change of the loading element input torque trajectory q times to calculate the loading element input torque trajectory and remaining q output parameters as constants of integration, so that a total number of output parameters associated with the loading element input torque trajectory is m;
calculate a loading element velocity trajectory based on the loading element input torque trajectory;
calculate a transmission output speed trajectory based on the loading element input torque trajectory and the loading element velocity trajectory;
differentiate the transmission output speed trajectory to calculate a transmission output acceleration trajectory;
calculate a power transmitting device torque trajectory for each of the transmitting devices based on the transmission output acceleration trajectory, the loading element input torque trajectory, a transmission input acceleration trajectory, and the transmission input torque trajectory;
calculate a power transmitting device speed trajectory for each of the transmitting devices based on the transmission input speed trajectory and the transmission output speed trajectory;
assign numerical values to a subset of the n input and m output parameters, the subset including m+n−p parameters, where p is a nonnegative integer less than m+n;
calculate numerical values for remaining p parameters, which were not included in the subset of n input and m output parameters receiving assigned numerical values, by satisfying p constraints on initial values of the loading element input torque trajectory, the first rate of change of the loading element input torque trajectory with respect to time, initial value of the transmission input speed trajectory, and initial and final values of the torque and speed trajectories of selected power transmitting devices;
calculate the torque and speed trajectories of the power transmitting devices using the numerical values of the m+n parameters; and
control the power transmitting devices in a manner prescribed by the torque and speed trajectories during a gearshift.

16. The controller of claim 15 wherein at least one of the trajectories and the numerical values are pre-calculated and loaded into a memory of the controller, and the controller determines the at least one of the trajectories and the numerical values by retrieving the at least one of the trajectories and the numerical values from the memory.

17. The controller of claim 15 wherein the controller comprises:
a micro-processor; and
a memory in communication with the micro-processor, the memory containing instructions that, when executed by the micro-processor, cause the controller to operate as configured.
